(19) United States
(12) Patent Application Publication
(10) Pub. No.: US 2023/0345512 A1
(43) Pub. Date: Oct. 26, 2023

(54) COMMUNICATION METHOD, APPARATUS, AND SYSTEM

(71) Applicant: Huawei technologies Co., Ltd., Shenzhen (CN)

(72) Inventors: Wenting Guo, Shenzhen (CN); Hongjia Su, Shanghai (CN); Lei Dong, Shanghai (CN); Lei Lu, Shanghai (CN)

(21) Appl. No.: 18/344,067

(22) Filed: Jun. 29, 2023

Related U.S. Application Data
(63) Continuation of application No. PCT/CN2020/142516, filed on Dec. 31, 2020.

(51) Int. Cl. H04W 72/51; H04W 72/0446; H04W 72/0453; H04W 28/26

(52) U.S. Cl. CPC H04W 72/51; H04W 72/0446; H04W 72/0453; H04W 28/26

(57) ABSTRACT

Embodiments of this application provide a communication method, apparatus, and system. The method includes: A first terminal apparatus determines coordination information, where the coordination information is used to assist a second terminal apparatus in determining a sidelink sending resource; and the first terminal apparatus sends the coordination information to the second terminal apparatus, where a sequence carrying the coordination information is mapped to a first time-frequency resource, the first time-frequency resource is a subset of a second time-frequency resource, and the second time-frequency resource and a physical sidelink feedback resource overlap in time domain, and are orthogonal in frequency domain.

### CROSS-REFERENCE TO RELATED APPLICATIONS

This application is a continuation of International Application No. PCT/CN2020/142516, filed on Dec. 31, 2020, the disclosure of which is hereby incorporated by reference in its entirety.

### TECHNICAL FIELD

This application relates to the field of communication technologies, and in particular, to a communication method, apparatus, and system.

### BACKGROUND

With development of wireless communication technologies, vehicle-to-everything (V2X) communication is increasingly popular. By using the V2X communication, road condition information around a vehicle can be obtained in real time, to better assist driving of the vehicle and even implement autonomous driving.

Currently, a transmission mode of the V2X communication includes a transmission mode 1 that is based on scheduling of a base station, and a transmission mode 2 in which user equipment (UE) autonomously selects an SL transmission resource. In the transmission mode 1, the base station uniformly allocates a sidelink (SL) transmission resource based on a buffer status report (BSR) of each UE. An advantage of the transmission mode 1 is that the SL transmission resource of each UE is uniformly scheduled by the base station, so that resource collision can be avoided. In the transmission mode 2, a transmit end UE first selects an SL transmission resource of the transmit end UE from a V2X communication resource pool, and then sends a physical sidelink control channel (PSCCH) and a physical sidelink shared channel (PSSCH) to a receive end UE on the SL transmission resource selected by the transmit end UE. Because the UE selects the SL transmission resource based on a sensing result of the UE, without depending on scheduling of the base station, the transmission mode 2 is not restricted by network coverage. That is, the transmit end UE can also perform communication without network coverage.

In a scenario of a hidden terminal shown in FIG. 1, a transmit end UE-B and a transmit end UE-C are far away from each other, and cannot sense a signal sent by each other, but a receive end UE-A is located between the transmit end UE-B and the transmit end UE-C, and can receive signals sent by the transmit end UE-B and the transmit end UE-C. If the transmission mode 2 of the existing V2X communication is used, because the transmit end UE-B and the transmit end UE-C cannot perceive presence of each other through sensing, when the transmit end UE-B sends a signal 1 to the receive end UE-A, and the transmit end UE-C sends a signal 2 to the receive end UE-A, an SL transmission resource of the signal 1 and an SL transmission resource of the signal 2 may overlap. Consequently, the signal 1 collides with the signal 2, affecting signal reception of the receive end UE-A. To resolve this problem, the receive end UE-A may send coordination information to the transmit end UE-B, to assist the transmit end UE-B in selecting an SL transmission resource. Alternatively, the receive end UE-A may send coordination information to the transmit end UE-C, to assist the transmit end UE-C in selecting an SL transmission resource.

Currently, in the transmission mode 2 of the existing V2X communication, both a PSSCH and a PSCCH need to be sent for information transmission between UEs. If the coordination information is transmitted through the PSSCH and/or the PSCCH in the V2X communication resource pool, because one PSSCH and/or one PSCCH occupy/occupies at least one sub-channel in one SL slot, each piece of coordination information needs to occupy an SL transmission resource of at least one sub-channel in one SL slot. In this way, resource overheads for transmitting the coordination information are high. In particular, when a plurality of pieces of coordination information need to be transmitted, a large number of physical resources are occupied, and transmission efficiency of other information is affected.

### SUMMARY

Embodiments of this application provide a communication method, apparatus, and system, to reduce resource overheads for sending coordination information.

To achieve the foregoing objectives, the following technical solutions are used in embodiments of this application.

According to a first aspect, a communication method is provided. A communication apparatus that performs the communication method may be a first terminal apparatus, or may be a module used in the first terminal apparatus, for example, a chip or a chip system. An example in which an execution body is the first terminal apparatus is used for description below. The first terminal apparatus determines coordination information, and the coordination information is used to assist a second terminal apparatus in determining a sidelink sending resource. The first terminal apparatus sends the coordination information to the second terminal apparatus. A sequence carrying the coordination information is mapped to a first time-frequency resource, the first time-frequency resource is a subset of a second time-frequency resource, and the second time-frequency resource and a physical sidelink feedback resource overlap in time domain, and are orthogonal in frequency domain. Because the physical sidelink feedback resource is less than one SL transmission slot in time domain, the coordination information is sent by using the subset of the second time-frequency resource that overlaps the physical sidelink feedback resource in time domain. Sending of the coordination information only needs to occupy some time domain resources in one SL transmission slot, without occupying at least one sub-channel in the entire slot, so that resource overheads for transmitting and sending the coordination information can be reduced. Especially when a plurality of pieces of coordination information need to be transmitted and sent, sending efficiency of other information transmission can be ensured.

With reference to the first aspect, in a possible implementation, a slot in which the second time-frequency resource is located is a slot that is after a first slot and in which a first physical sidelink feedback resource is located at a gap greater than K₁ slots from a last symbol in the first slot, and the second terminal apparatus sends a physical sidelink channel in the first slot. Alternatively, a slot in which the second time-frequency resource is located is a slot that is before a second slot and in which a first physical sidelink feedback resource is located at a gap greater than K₂ slots from a first symbol in the second slot. The second slot is a slot in which a first reserved resource of the second terminal apparatus is located, the first reserved resource is a reserved resource closest to the first slot, and K₁ or K₂ is a minimum time gap configured by a higher layer for sending the coordination information. If the slot in which the second time-frequency resource determined by using K₁ is located is before the slot in which the second time-frequency resource determined by using K₂ is located, an advantage of selecting the slot in which the second time-frequency resource determined by using K₁ is located to send the coordination information is that the second terminal apparatus may be notified as soon as possible, to trigger the second terminal apparatus to perform SL resource selection, reselection or collision confirmation as soon as possible. An advantage of selecting the slot in which the second time-frequency resource determined by using K₂ is located to send the coordination information is that more time may be provided for the first terminal apparatus, so that the first terminal apparatus generates more comprehensive and reliable coordination information.

With reference to the first aspect, in a possible implementation, the second time-frequency resource includes J*M third time-frequency resources. The J*M third time-frequency resources are sequentially allocated to M sub-channels in J slots in a manner of frequency domain first and then time domain. The J slots are slots corresponding to the second time-frequency resource determined based on K₁ or K₂, and M is a number of sub-channels configured in a resource pool. Because the third time-frequency resources are continuous in frequency domain of the second time-frequency resource in the manner of frequency domain first and then time domain, a time domain peak-to-average ratio of a to-be-sent signal can be reduced, so that average power of the signal can be increased when the coordination information is sent. In this way, actual power of each sending sequence is increased, and technical effect of expanding a signal coverage area is finally achieved.

With reference to the first aspect, in a possible implementation, the first time-frequency resource includes M₁ third time-frequency resources in the J*M third time-frequency resources. M₁ is a number of sub-channels occupied by the second terminal apparatus to transmit and send the physical sidelink channel in the first slot, and M₁ is a positive integer less than or equal to M. The third time-frequency resource is a minimum granularity of the second time-frequency resource. Because the first time-frequency resource includes the M₁ third time-frequency resources, one third time-frequency resource may be allocated to each sub-channel in each slot occupied for sending the physical sidelink channel. Therefore, resource allocation for sending the coordination information can be ensured to be proper.

With reference to the first aspect, in a possible implementation, the coordination information includes first information. The first information indicates a resource usage status in the first slot, and the second terminal apparatus sends the physical sidelink channel in the first slot. Because the first information indicates the resource usage status in the first slot, when performing resource selection subsequently, the second terminal apparatus may select a transmission resource that is not occupied by another terminal apparatus, or select a transmission resource that is occupied by another terminal apparatus but has a lower data priority, without excluding all candidate resources in a slot in a resource selection window that corresponds to the slot for sending the physical sidelink channel by the second terminal apparatus, to avoid a possible resource conflict, thereby improving resource utilization.

With reference to the first aspect, in a possible implementation, that the first information indicates a resource usage status in the first slot includes: The first information indicates resource usage statuses of M sub-channels in the first slot, and M is the number of sub-channels configured in the resource pool. Alternatively, the first information indicates resource usage statuses of sub-channels other than the M₁ sub-channels in the M sub-channels in the first slot, M is the number of sub-channels configured in the resource pool, and M₁ is the number of sub-channels occupied by the second terminal apparatus to send the physical sidelink channel in the first slot. M bits or M-M₁ bits may be used for the first information. An advantage of using M bits for the first information is that a use status of each sub-channel in the first slot can be more accurately and comprehensively indicated. An advantage of using M-M₁ bits for the first information is that frequency domain resources required for sending the coordination information can be saved. In this way, resource overheads for sending the coordination information are reduced.

With reference to the first aspect, in a possible implementation, the coordination information further includes second information. The second information indicates that the first reserved resource of the second terminal apparatus collides with a reserved resource of another terminal apparatus. The first reserved resource is a reserved resource closest to the first slot, and the second terminal apparatus sends the physical sidelink channel in the first slot. In other words, in this solution, the first terminal apparatus may determine the coordination information including the second information, to trigger the second terminal apparatus to perform collision confirmation or reselect a transmission resource, thereby achieving technical effect of reducing a collision probability.

With reference to the first aspect, in a possible implementation, the first reserved resource is used for retransmission of a first transport block TB on the physical sidelink channel of the second terminal apparatus; and/or, the first reserved resource is used for new transmission of a service to which a second TB belongs on the physical sidelink channel of the second terminal apparatus in a next period. Because the first reserved resource may be used for retransmission of a same TB, or may be used for new transmission of different TBs, the communication method provided in this application is applicable to a plurality of TB transmission scenarios.

With reference to the first aspect, in a possible implementation, the first reserved resource includes M₃ reserved sub-channel resources.

With reference to the first aspect, in a possible implementation, the first reserved resource is indicated by a time resource indicator value TRIV on the physical sidelink channel of the second terminal apparatus. Alternatively, the first reserved resource is indicated by a resource reservation period on the physical sidelink channel of the second terminal apparatus. In other words, in this embodiment of this application, the first reserved resource may be indicated by a plurality of parameters.

With reference to the first aspect, in a possible implementation, the coordination information further includes indication information. The indication information indicates that the coordination information includes the first information and/or the second information. The first information indicates the resource usage status in the first slot. The second information indicates that the first reserved resource of the second terminal apparatus collides with the reserved resource of the another terminal apparatus. The first reserved resource is the reserved resource closest to the first slot, and the second terminal apparatus sends the physical sidelink channel in the first slot. Because the coordination information includes the indication information, the second terminal apparatus can identify different types included in the received coordination information, and identify corresponding coordination information based on the type, to select a sidelink sending resource based on the coordination information. In this way, technical effect of improving resource utilization and/or reducing a collision probability is implemented.

According to a second aspect, a communication method is provided. A communication apparatus that performs the communication method may be a second terminal apparatus, or may be a module used in the second terminal apparatus, for example, a chip or a chip system. An example in which an execution body is the second terminal apparatus is used for description below. The second terminal apparatus receives coordination information from a first terminal apparatus. A sequence carrying the coordination information is mapped to a first time-frequency resource, the first time-frequency resource is a subset of a second time-frequency resource, and the second time-frequency resource and a physical sidelink feedback resource overlap in time domain, and are orthogonal in frequency domain. The second terminal apparatus determines a sidelink sending resource based on the coordination information.

With reference to the second aspect, in a possible implementation, a slot in which the second time-frequency resource is located is a slot that is after a first slot and in which a first physical sidelink feedback resource is located at a gap greater than K₁ slots from a last symbol in the first slot, and the second terminal apparatus sends a physical sidelink channel in the first slot. Alternatively, a slot in which the second time-frequency resource is located is a slot that is before a second slot and in which a first physical sidelink feedback resource is located at a gap greater than K₂ slots from a first symbol in the second slot, the second slot is a slot in which a first reserved resource of the second terminal apparatus is located, and the first reserved resource is a reserved resource closest to the first slot, and K₁ or K₂ is a minimum time gap configured by a higher layer for sending the coordination information.

With reference to the second aspect, in a possible implementation, the second time-frequency resource includes J*M third time-frequency resources, and the J*M third time-frequency resources are sequentially allocated to M sub-channels in J slots in a manner of frequency domain first and then time domain. The J slots are slots corresponding to the second time-frequency resource determined based on K₁ or K₂, and M is a number of sub-channels configured in a resource pool.

With reference to the second aspect, in a possible implementation, the first time-frequency resource includes M₁ third time-frequency resources in the J*M third time-frequency resources. M₁ is a number of sub-channels occupied by the second terminal apparatus to transmit and send the physical sidelink channel in the first slot, and M₁ is a positive integer less than or equal to M.

With reference to the second aspect, in a possible implementation, the coordination information includes first information. The first information indicates a resource usage status in the first slot, and the second terminal apparatus sends the physical sidelink channel in the first slot.

With reference to the second aspect, in a possible implementation, that the first information indicates a resource usage status in the first slot includes: The first information indicates resource usage statuses of M sub-channels in the first slot, and M is the number of sub-channels configured in the resource pool. Alternatively, the first information indicates resource usage statuses of sub-channels other than the M₁ sub-channels in the M sub-channels in the first slot, M is the number of sub-channels configured in the resource pool, and M₁ is the number of sub-channels occupied by the second terminal apparatus to send the physical sidelink channel in the first slot.

With reference to the second aspect, in a possible implementation, the coordination information further includes second information. The second information indicates that the first reserved resource of the second terminal apparatus collides with a reserved resource of another terminal apparatus. The first reserved resource is a reserved resource closest to the first slot, and the second terminal apparatus sends the physical sidelink channel in the first slot.

With reference to the second aspect, in a possible implementation, the first reserved resource is used for retransmission of a first transport block TB on the physical sidelink channel of the second terminal apparatus; and/or, the first reserved resource is used for new transmission of a service to which a second TB belongs on the physical sidelink channel of the second terminal apparatus in a next period.

With reference to the second aspect, in a possible implementation, the first reserved resource includes M₃ reserved sub-channel resources.

With reference to the second aspect, in a possible implementation, the first reserved resource is indicated by a time resource indicator value TRIV on the physical sidelink channel of the second terminal apparatus. Alternatively, the first reserved resource is indicated by a resource reservation period on the physical sidelink channel of the second terminal apparatus.

With reference to the second aspect, in a possible implementation, the coordination information further includes indication information. The indication information indicates that the coordination information includes the first information and/or the second information. The first information indicates the resource usage status in the first slot. The second information indicates that the first reserved resource of the second terminal apparatus collides with the reserved resource of the another terminal apparatus. The first reserved resource is the reserved resource closest to the first slot, and the second terminal apparatus sends the physical sidelink channel in the first slot.

For technical effect brought by any possible implementation of the second aspect, refer to technical effect brought by different implementations of the first aspect. Details are not described herein again.

According to a third aspect, a communication apparatus is provided, to implement the foregoing methods. The communication apparatus includes a corresponding module, unit, or means (means) for implementing the foregoing method. The module, the unit, or the means may be implemented by hardware or software, or implemented by hardware by executing corresponding software. The hardware or the software includes one or more modules or units corresponding to the foregoing functions.

With reference to the third aspect, in a possible implementation, the communication apparatus includes a transceiver module and a processing module. The processing module is configured to determine coordination information, where the coordination information is used to assist a second terminal apparatus in determining a sidelink sending resource. The transceiver module is configured to send the coordination information to the second terminal apparatus, where a sequence carrying the coordination information is mapped to a first time-frequency resource, the first time-frequency resource is a subset of a second time-frequency resource, and the second time-frequency resource and a physical sidelink feedback resource overlap in time domain, and are orthogonal in frequency domain.

With reference to the third aspect, in a possible implementation, a slot in which the second time-frequency resource is located is a slot that is after a first slot and in which a first physical sidelink feedback resource is located at a gap greater than K₁ slots from a last symbol in the first slot, and the second terminal apparatus sends a physical sidelink channel in the first slot. Alternatively, a slot in which the second time-frequency resource is located is a slot that is before a second slot and in which a first physical sidelink feedback resource is located at a gap greater than K₂ slots from a first symbol in the second slot. The second slot is a slot in which a first reserved resource of the second terminal apparatus is located, the first reserved resource is a reserved resource closest to the first slot, and K₁ or K₂ is a minimum time gap configured by a higher layer for sending the coordination information.

With reference to the third aspect, in a possible implementation, the second time-frequency resource includes J*M third time-frequency resources, and the J*M third time-frequency resources are sequentially allocated to M sub-channels in J slots in a manner of frequency domain first and then time domain. The J slots are slots corresponding to the second time-frequency resource determined based on K₁ or K₂, and M is a number of sub-channels configured in a resource pool.

With reference to the third aspect, in a possible implementation, the first time-frequency resource includes M₁ third time-frequency resources in the J*M third time-frequency resources. M₁ is a number of sub-channels occupied by the second terminal apparatus to transmit and send the physical sidelink channel in the first slot, and M₁ is a positive integer less than or equal to M.

With reference to the third aspect, in a possible implementation, the coordination information includes first information. The first information indicates a resource usage status in the first slot, and the second terminal apparatus sends the physical sidelink channel in the first slot.

With reference to the third aspect, in a possible implementation, that the first information indicates a resource usage status in the first slot includes: The first information indicates resource usage statuses of M sub-channels in the first slot, and M is the number of sub-channels configured in the resource pool. Alternatively, the first information indicates resource usage statuses of sub-channels other than the M₁ sub-channels in the M sub-channels in the first slot, M is the number of sub-channels configured in the resource pool, and M₁ is the number of sub-channels occupied by the second terminal apparatus to send the physical sidelink channel in the first slot.

With reference to the third aspect, in a possible implementation, the coordination information further includes second information. The second information indicates that the first reserved resource of the second terminal apparatus collides with a reserved resource of another terminal apparatus. The first reserved resource is a reserved resource closest to the first slot, and the second terminal apparatus sends the physical sidelink channel in the first slot.

With reference to the third aspect, in a possible implementation, the first reserved resource is used for retransmission of a first transport block TB on the physical sidelink channel of the second terminal apparatus; and/or, the first reserved resource is used for new transmission of a service to which a second TB belongs on the physical sidelink channel of the second terminal apparatus in a next period.

With reference to the third aspect, in a possible implementation, the first reserved resource includes M₃ reserved sub-channel resources.

With reference to the third aspect, in a possible implementation, the first reserved resource is indicated by a time resource indicator value TRIV on the physical sidelink channel of the second terminal apparatus. Alternatively, the first reserved resource is indicated by a resource reservation period on the physical sidelink channel of the second terminal apparatus.

With reference to the third aspect, in a possible implementation, the coordination information further includes indication information. The indication information indicates that the coordination information includes the first information and/or the second information. The first information indicates the resource usage status in the first slot. The second information indicates that the first reserved resource of the second terminal apparatus collides with the reserved resource of the another terminal apparatus. The first reserved resource is the reserved resource closest to the first slot, and the second terminal apparatus sends the physical sidelink channel in the first slot.

With reference to the third aspect, in a possible implementation, the processing module may be a processor, and the transceiver module may be a communication module connected by using a communication interface.

According to a fourth aspect, a communication apparatus is provided, to implement the foregoing method. The communication apparatus includes a corresponding module, unit, or means (means) for implementing the foregoing method. The module, the unit, or the means may be implemented by hardware or software, or implemented by hardware by executing corresponding software. The hardware or the software includes one or more modules or units corresponding to the foregoing functions.

With reference to the fourth aspect, in a possible implementation, the communication apparatus includes a transceiver module and a processing module. The transceiver module is configured to receive coordination information from a first terminal apparatus. A sequence carrying the coordination information is mapped to a first time-frequency resource, and the first time-frequency resource is a subset of a second time-frequency resource. The second time-frequency resource and a physical sidelink feedback resource overlap in time domain, and are orthogonal in frequency domain. The processing module is configured to determine a sidelink sending resource based on the coordination information.

With reference to the fourth aspect, in a possible implementation, a slot in which the second time-frequency resource is located is a slot that is after a first slot and in which a first physical sidelink feedback resource is located at a gap greater than K₁ slots from a last symbol in the first slot, and the second terminal apparatus sends a physical sidelink channel in the first slot. Alternatively, a slot in which the second time-frequency resource is located is a slot that is before a second slot and in which a first physical sidelink feedback resource is located at a gap greater than K₂ slots from a first symbol in the second slot. The second slot is a slot in which a first reserved resource of the second terminal apparatus is located, the first reserved resource is a reserved resource closest to the first slot, and K₁ or K₂ is a minimum time gap configured by a higher layer for sending the coordination information.

With reference to the fourth aspect, in a possible implementation, the second time-frequency resource includes J*M third time-frequency resources, and the J*M third time-frequency resources are sequentially allocated to M sub-channels in J slots in a manner of frequency domain first and then time domain. The J slots are slots corresponding to the second time-frequency resource determined based on K₁ or K₂, and M is a number of sub-channels configured in a resource pool.

With reference to the fourth aspect, in a possible implementation, the first time-frequency resource includes M₁ third time-frequency resources in the J*M third time-frequency resources. M₁ is a number of sub-channels occupied by the second terminal apparatus to transmit and send the physical sidelink channel in the first slot, and M₁ is a positive integer less than or equal to M.

With reference to the fourth aspect, in a possible implementation, the coordination information includes first information. The first information indicates a resource usage status in the first slot, and the second terminal apparatus sends the physical sidelink channel in the first slot.

With reference to the fourth aspect, in a possible implementation, that the first information indicates a resource usage status in the first slot includes: The first information indicates resource usage statuses of M sub-channels in the first slot, and M is the number of sub-channels configured in the resource pool. Alternatively, the first information indicates resource usage statuses of sub-channels other than the M₁ sub-channels in the M sub-channels in the first slot, M is the number of sub-channels configured in the resource pool, and M₁ is the number of sub-channels occupied by the second terminal apparatus to send the physical sidelink channel in the first slot.

With reference to the fourth aspect, in a possible implementation, the coordination information further includes second information. The second information indicates that the first reserved resource of the second terminal apparatus collides with a reserved resource of another terminal apparatus. The first reserved resource is a reserved resource closest to the first slot, and the second terminal apparatus sends the physical sidelink channel in the first slot.

With reference to the fourth aspect, in a possible implementation, the first reserved resource is used for retransmission of a first transport block TB on the physical sidelink channel of the second terminal apparatus; and/or, the first reserved resource is used for new transmission of a service to which a second TB belongs on the physical sidelink channel of the second terminal apparatus in a next period.

With reference to the fourth aspect, in a possible implementation, the first reserved resource includes M₃ reserved sub-channel resources.

With reference to the fourth aspect, in a possible implementation, the first reserved resource is indicated by a time resource indicator value TRIV on the physical sidelink channel of the second terminal apparatus. Alternatively, the first reserved resource is indicated by a resource reservation period on the physical sidelink channel of the second terminal apparatus.

With reference to the fourth aspect, in a possible implementation, the coordination information further includes indication information. The indication information indicates that the coordination information includes the first information and/or the second information. The first information indicates the resource usage status in the first slot. The second information indicates that the first reserved resource of the second terminal apparatus collides with the reserved resource of the another terminal apparatus. The first reserved resource is the reserved resource closest to the first slot, and the second terminal apparatus sends the physical sidelink channel in the first slot.

According to a fifth aspect, a communication apparatus is provided. The communication apparatus includes a processor. The processor is configured to: after being coupled to a memory and reading computer instructions in the memory, perform, according to the instructions, the method according to any one of the foregoing aspects.

With reference to the fifth aspect, in a possible implementation, the communication apparatus further includes a memory. The memory is configured to store computer instructions.

With reference to the fifth aspect, in a possible implementation, the communication apparatus further includes a communication interface. The communication interface is used by the communication apparatus to communicate with another device. For example, the communication interface may be a transceiver, an input/output interface, an interface circuit, an output circuit, an input circuit, a pin, or a related circuit.

With reference to the fifth aspect, in a possible implementation, the communication apparatus may be a chip or a chip system. When the communication apparatus is the chip system, the communication apparatus may include a chip, or may include the chip and another discrete device.

With reference to the fifth aspect, in a possible implementation, when the communication apparatus is a chip or a chip system, the communication interface may be an input/output interface, an interface circuit, an output circuit, an input circuit, a pin, a related circuit, or the like on the chip or the chip system. The processor may also be embodied as a processing circuit or a logic circuit.

According to a sixth aspect, a computer-readable storage medium is provided. The computer-readable storage medium stores instructions, and when the instructions are run on a computer, the computer is enabled to perform the method according to any one of the foregoing aspects.

According to a seventh aspect, a computer program product including instructions is provided. When the computer program product runs on a computer, the computer is enabled to perform the method according to any one of the foregoing aspects.

For technical effect brought by any possible implementation of the third aspect to the seventh aspect, refer to technical effect brought by different implementations of the first aspect or the second aspect. Details are not described herein again.

According to an eighth aspect, a communication system is provided. The communication system includes a first terminal apparatus that performs the method according to the first aspect and a second terminal apparatus that performs the method according to the second aspect.

### BRIEF DESCRIPTION OF THE DRAWINGS

FIG. 1 is a schematic diagram of a scenario of a hidden terminal according to an embodiment of this application;

FIG. 2 is a schematic diagram of a scenario of V2V communication in the conventional technology;

FIG. 3 is a schematic diagram of signal transmission in a transmission mode 1 of V2X communication in the conventional technology;

FIG. 4 is a schematic diagram 1 in which a base station indicates a time domain resource of a V2X communication resource pool by using a bit map in the conventional technology;

FIG. 5A is a schematic diagram 2 in which a base station indicates a time domain resource of a V2X communication resource pool by using a bit map in the conventional technology;

FIG. 5B is a schematic diagram of a time-frequency domain resource of a V2X communication resource pool in the conventional technology;

FIG. 6 is a schematic diagram of PSFCH resource configuration in a period in the conventional technology;

FIG. 7 is a schematic diagram of a bit map of a PSFCH frequency domain resource configured in a V2X communication resource pool in the conventional technology;

FIG. 8 is a schematic diagram of determining a slot in which a PSFCH resource is located based on a minimum time gap K in the conventional technology;

FIG. 9 is a schematic diagram of allocating a PSFCH resource to each sub-channel in a bound PSSCH slot in a manner of time domain first and then frequency domain in the conventional technology;

FIG. 10 is a schematic diagram 1 of SL transmission resource selection in the conventional technology;

FIG. 11 is a schematic diagram of candidate resources in a frequency domain resource of a V2X communication resource pool in the conventional technology;

FIG. 12 is a schematic diagram 2 of SL transmission resource selection in the conventional technology;

FIG. 13 is a schematic diagram of an architecture of a communication system according to an embodiment of this application;

FIG. 14 is a schematic diagram of a structure of a terminal apparatus according to an embodiment of this application;

FIG. 15 is a communication method according to an embodiment of this application;

FIG. 16 is a schematic diagram of sending coordination information according to an embodiment of this application;

FIG. 17 is another schematic diagram of sending coordination information according to an embodiment of this application;

FIG. 18 is a schematic diagram of allocating a resource for sending coordination information to each sub-channel in a bound PSSCH slot in a manner of frequency domain first and then time domain according to an embodiment of this application; and

FIG. 19 is a schematic diagram of a structure of a communication apparatus according to an embodiment of this application.

### DETAILED DESCRIPTION OF ILLUSTRATIVE EMBODIMENTS

For ease of understanding technical solutions in embodiments of this application, the following first briefly describes technologies or terms related to this application.

In embodiments of this application, an SL transmission slot is a slot available for SL transmission, a PSFCH resource is a resource available for sending a PSFCH, and a PSFCH slot is a slot that includes the PSFCH resource. In some expressions, a meaning of “transmission” is equivalent to “sending”. For example, a “transmission resource” may be understood as a “sending resource”, and a “transmission slot” may be understood as a “sending slot”, which is uniformly described herein. Details are not described below.

First: Device-to-Device (D2D) Communication

The D2D communication allows a plurality of UEs that support a D2D function to perform direct discovery and direct communication regardless of whether there is a network device. Correspondingly, an Internet-of-vehicles application scenario based on the D2D communication is also provided. In the Internet-of-vehicles application scenario, to ensure driving safety, a requirement on a communication delay is very high. However, the existing D2D communication cannot technically meet the delay requirement in the Internet-of-vehicles scenario.

Second: Vehicle-to-Vehicle (V2V) Communication

A typical scenario of the V2V communication is shown in FIG. 2. A moving vehicle may directly exchange information with another nearby vehicle through the V2V communication, to obtain status information and road condition information of the another vehicle in real time, to better assist driving of the vehicle and even implement autonomous driving.

Third: V2X Communication

The V2X communication may implement interconnection between a vehicle and the outside by using an apparatus (such as a sensor or an in-vehicle terminal) that is configured on the vehicle and various communication technologies. The V2X communication may include interconnection communication such as V2V, vehicle-to-pedestrian (V2P), and vehicle-to-roadway infrastructure (V2I). Information transmission in the V2X communication is based on SL transmission, and may be understood as application of the SL transmission in the Internet of Vehicles.

Fourth: A Transmission Mode of V2X Communication

The transmission mode of V2X communication includes a transmission mode 1 based on scheduling of a base station, and a transmission mode 2 in which UE autonomously selects an SL transmission resource.

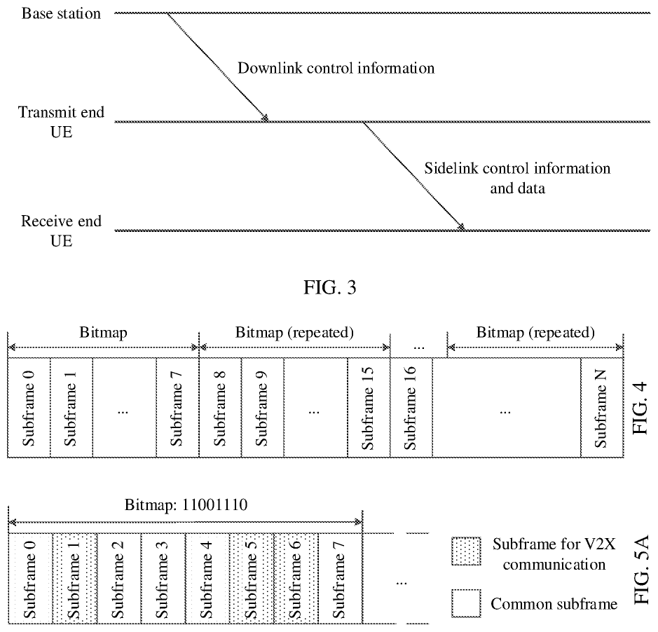

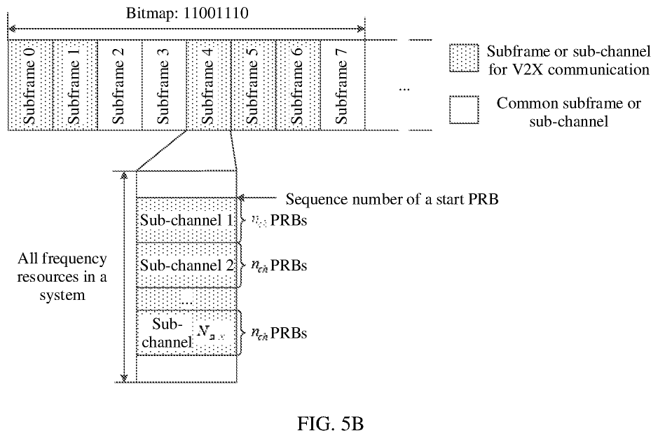

In the transmission mode 1 shown in FIG. 3, the base station uniformly allocates SL transmission resources based on BSRs of UEs. An allocation mode of the SL transmission resource may be a dynamic mode or a preconfigured mode. Then, the base station may notify a transmit end UE of the SL transmission resource by using downlink control information (downlink control information, DCI). After receiving the DCI, the transmit end UE sends sidelink control information (sidelink control information, SCI) and data to a receive end UE on the SL transmission resource indicated by the DCI. The SCI is transmitted by using a PSCCH, and the data is transmitted by using a PSSCH. An advantage of the transmission mode 1 is that the SL transmission resource of each UE is uniformly scheduled by the base station, so that resource collision can be avoided. However, when the transmit end UE has no network coverage, the transmission mode 1 cannot be used.

In the transmission mode 2, the UE autonomously selects the SL transmission resource from a V2X communication resource pool for communication, without depending on uniform allocation by the base station. Specifically, the transmit end UE first autonomously selects the SL transmission resource of the transmit end UE from the V2X communication resource pool, and then sends the SCI and the data to the receive end UE on the SL transmission resource selected by the transmit end UE. The SCI is transmitted by using a PSCCH, and the data is transmitted by using a PSSCH. Because the UE selects the SL transmission resource based on a sensing result of the UE, without depending on scheduling of the base station, the transmission mode 2 is not restricted by network coverage. That is, the transmit end UE can also perform communication without network coverage. However, in this transmission mode, each UE separately performs sensing and selection of the SL transmission resource. Therefore, resource collision may occur.

In this embodiment of this application, the SL transmission resource includes an initial SL transmission resource and/or a retransmission resource. A unified description is provided herein. Details are not described below.

Fifth: A V2X Communication Resource Pool

A time-frequency resource required for V2X communication may be configured based on the V2X communication resource pool. The V2X communication resource pool may be considered as a set including a time domain resource and a frequency domain resource for V2X communication.

For the time domain resource used for V2X communication, the base station uses one bit map, and periodically repeats the bit map to indicate a set of subframes that are in all subframes in a communication system and that are used for V2X communication. For example, as shown in FIG. 4, a length of the bit map is 8 bits, and the bit map is periodically repeated in N subframes. A number of symbols occupied by SL transmission in each subframe is fixed M, and M may be considered as time domain transmission duration or a time domain transmission unit of one SL transmission. For example, a value of the bitmap in FIG. 5a may be “11001110”, where “1” represents a subframe used for V2X communication, and “0” represents a common subframe. Subframe 0 to subframe 7 are used as an example. When the value of the bitmap is “11001110”, it indicates that the subframe 0, the subframe 1, the subframe 4, the subframe 5, or the subframe 6 may be used for V2X communication, and the rest subframe 2, subframe 3, or subframe 7 is a common subframe and cannot be used for V2X communication.

For the frequency domain resource used for V2V communication, the base station may divide the frequency domain resource for V2V communication into several sub-channels, and each sub-channel may include a fixed number of physical resource blocks (physical resource blocks, PRBs). For example, FIG. 5b may be obtained by expanding the subframe 4 in FIG. 5a in frequency domain. A frequency resource used for V2X communication belongs to the V2X communication resource pool, the V2X communication resource pool has N_{subch} sub-channels in total, and each sub-channel includes n_{ch} PRBs. In this embodiment of this application, a sequence number of a start PRB of the frequency resource used for V2X communication may be indicated by the base station. Because a granularity for scheduling the frequency resource in the V2X communication resource pool may be a sub-channel, one SL transmission may occupy one or more sub-channels.

Sixth: Hybrid Automatic Repeat Request-Acknowledgement (HARQ-ACK) Feedback

In a new radio (NR) system in the fifth generation (5G) mobile communication system, V2X communication supports physical layer HARQ-ACK feedback. That is, for one PSSCH and PSCCH transmission, if the transmit end UE carries HARQ-ACK feedback enabling information in SCI included in a PSCCH, the receive end UE needs to feed back corresponding acknowledgment/negative acknowledgment (ACK/NACK) information based on a decoding result of a PSSCH this time. The ACK/NACK information is transmitted by using a physical sidelink feedback channel (PSFCH).

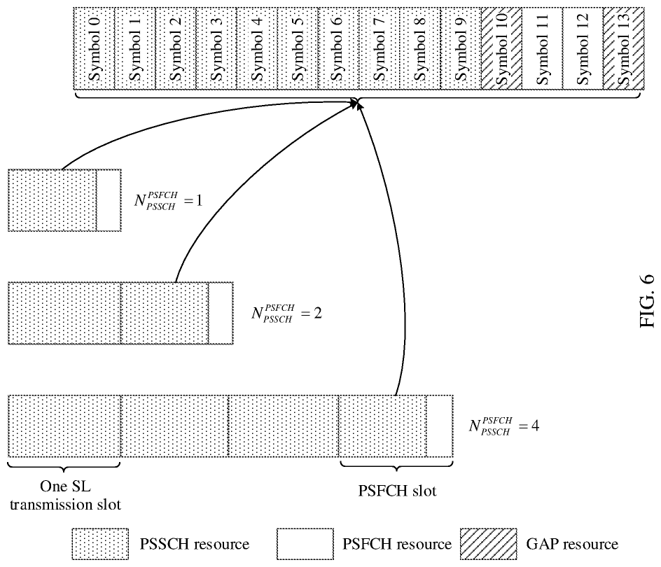

In the NR system, the V2X communication resource pool configures periodic time domain resources for a PSFCH resource, and a value of a period configuration parameter N_{PSSCH}^{PSFCH} for the PSFCH resource may be 0, 1, 2, or 4. N_{PSSCH}^{PSFCH}=0 indicates that there is no PSFCH resource configuration in the communication resource pool, that is, a resource in the communication resource pool is unavailable for sending a PSFCH, that is, the communication system does not support the physical layer HARQ-ACK feedback. N_{PSSCH}^{PSFCH}=1, 2, 4 indicates that every N_{PSSCH}^{PSFCH} SL transmission slots include one PSFCH slot. FIG. 6 shows PSFCH resource configuration in one period. When N_{PSSCH}^{PSFCH}=1, each SL transmission slot includes one PSFCH slot. When N_{PSSCH}^{PSFCH}=2, every two SL transmission slots include one PSFCH slot. When N_{PSSCH}^{PSFCH}=4, every four SL transmission slots include one PSFCH slot. As shown in FIG. 6, in a slot in which a PSFCH resource is located, the last two orthogonal frequency division multiplexing (orthogonal frequency division multiplexing, OFDM) symbols before a gap (GAP) is occupied by a PSFCH slot.

In a scenario of the transmission mode 2 of V2X communication, the UE needs to autonomously select an SL transmission resource based on a sensing result of the UE. Therefore, a PSFCH resource is configured in frequency domain for each sub-channel in the V2X communication resource pool of the NR system, to simplify a PSFCH resource selection process. Specifically, a process of determining a PSFCH resource corresponding to each sub-channel includes the following steps.

First, a bit map of a PSFCH frequency domain resource is configured.

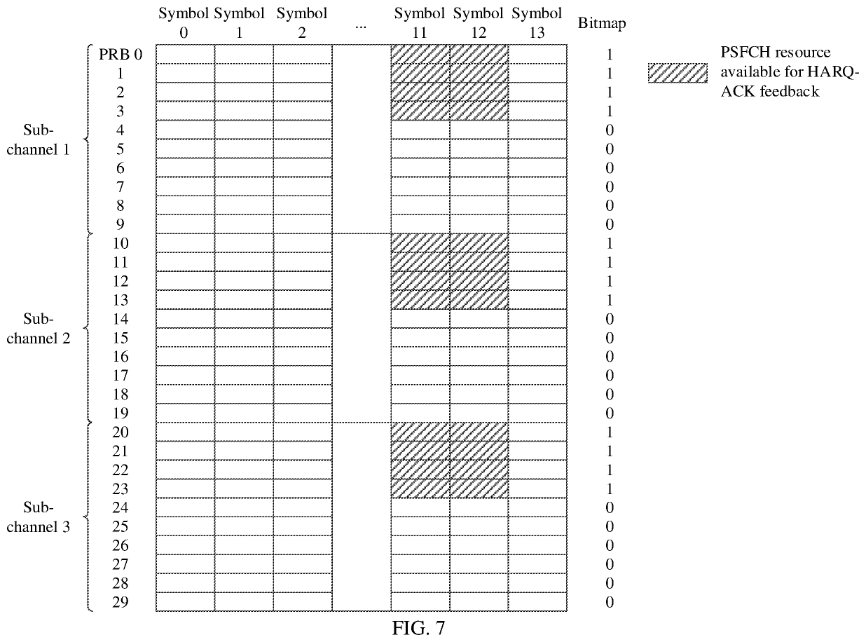

Specifically, the bit map of the PSFCH frequency domain resource is configured in the V2X communication resource pool. The bit map indicates whether each PRB in the frequency domain resource in the V2X communication resource pool is a PSFCH resource available for the HARQ-ACK feedback. In other words, a length of bit information included in the bit map is equal to a number of PRBs in the communication resource pool. “1” in the bit map indicates that a corresponding PRB is a PSFCH resource available for the HARQ-ACK feedback. On the contrary, “0” in the bit map indicates that a corresponding PRB is not a PSFCH resource. For example, it is assumed that the V2X communication resource pool has three sub-channels in total, and each sub-channel includes 10 PRBs, that is, N_{subch}=3 and n_{ch}=10. FIG. 7 can be obtained by expanding one SL transmission slot including a PSFCH slot in FIG. 6 in time domain and frequency domain. The bit map of the PSFCH frequency domain resource includes 3×10=30 bits in total, that is, a length of bit information included in the bit map is 30, and each bit indicates whether a corresponding PRB is available for sending an ACK/NACK signal. In the schematic diagram of PSFCH resource configuration shown in FIG. 7, the bit map indicates that the first four PRBs of each sub-channel are available for sending the ACK/NACK signal on a PSFCH.

Then, a number of PRBs of a PSFCH resource corresponding to each sub-channel is determined.

Because every N_{PSSCH}^{PSFCH} SL transmission slots include one PSFCH slot, for a V2X communication resource pool including N_{subch} sub-channels, a number of PRBs of a PSFCH resource corresponding to each sub-channel meets the following formula (1):

M_{subch,slot}^{PSFCH}=M_{PRB,set}^{PSFCH}/(N_{subch}·N_{PSSCH}^{PSFCH}); Formula (1)

M_{PRB,set}^{PSFCH} represents a number of PRBs of a frequency domain resource available for PSFCH sending, that is, a total number of bits whose values each are “1” in the bit map of the PSFCH frequency domain resource. FIG. 7 is used as an example. In a bit map with a length of 30, there are 12 bits with values of “1” in total. Therefore, a value of M_{PRB,set}^{PSFCH} is 12, and a number of sub-channels N_{subch} is 3. It is assumed that a value of a period configuration parameter N_{PSSCH}^{PSFCH} is 4, and a value of M_{subch,slot}^{PSFCH} obtained through calculation is 1. That is, the V2X communication resource pool configures a PSFCH resource of one PRB for each sub-channel in each SL transmission slot.

Then, a slot in which the PSFCH resource available for the HARQ-ACK feedback is specifically located is determined based on a minimum time gap K.

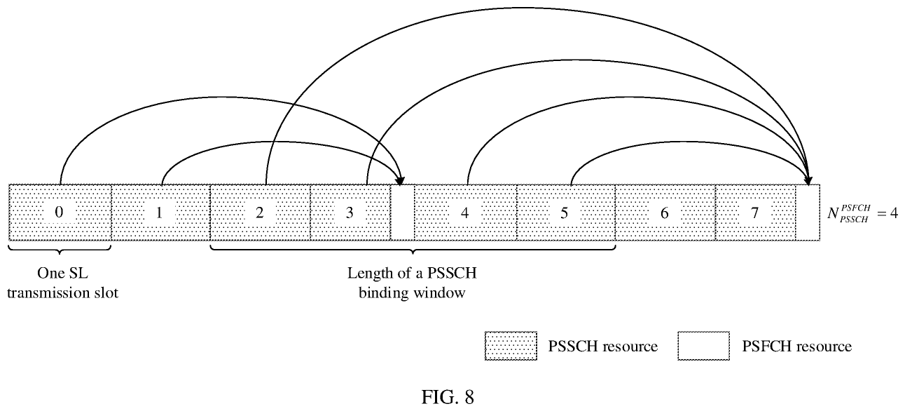

Due to a limitation of a decoding capability of the receive end UE, the receive end UE cannot immediately perform feedback after receiving a PSSCH. Therefore, the minimum time gap K may be defined, and a value of the minimum time gap is configured by the V2X communication resource pool. That is, the PSFCH is sent in a first available slot that includes a PSFCH resource, and the slot is located at least at a gap of K slots from a slot in which the PSSCH is located. A case in which N_{PSSCH}^{PSFCH}=4 in FIG. 6 is used as an example. As shown in FIG. 8, when K=2, a PSSCH carried in an SL transmission slot 0 or an SL transmission slot 1 may be fed back on a PSFCH resource in an SL transmission slot 3. A PSSCH carried in an SL transmission slot 2, an SL transmission slot 3, an SL transmission slot 4, or an SL transmission slot 5 may be fed back on a PSFCH resource in an SL transmission slot 7. Because the PSSCH carried in the slot 2, the slot 3, the slot 4, or the slot 5 may be fed back on a PSFCH resource in a same slot, the SL transmission slot 2, the SL transmission slot 3, the SL transmission slot 4, and the SL transmission slot 5 may be referred to as a PSSCH binding window.

Finally, a PSFCH resource in one PSFCH slot is sequentially allocated to each sub-channel in the PSSCH binding window in a manner of time domain first and then frequency domain.

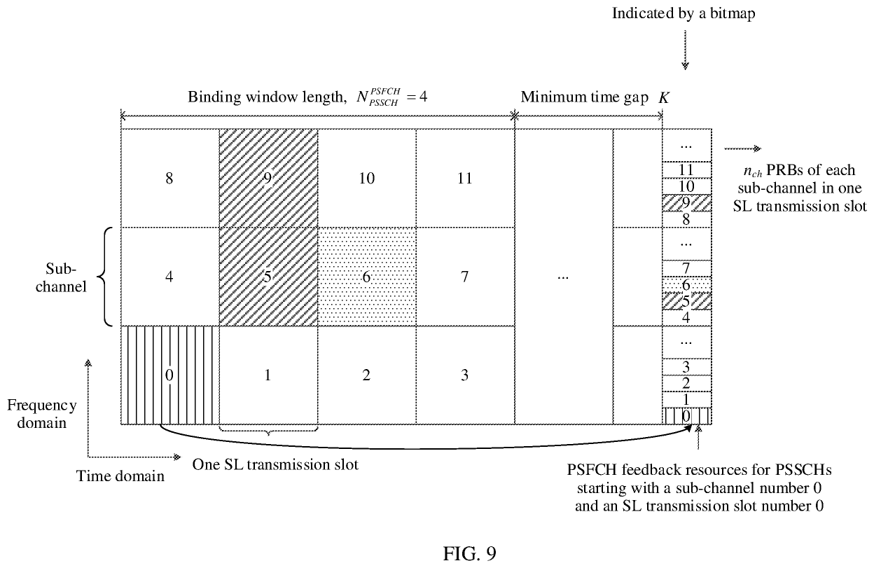

For example, with reference to FIG. 7 and FIG. 8, as shown in FIG. 9, when N_{PSSCH}^{PSFCH}=4, a PSFCH resource corresponding to each sub-channel in the four bound PSSCH slots is shown by numbers 0 to 11 in the figure. In other words, the V2X communication resource pool allocates a PSFCH resource of one PRB to each sub-channel in each SL transmission slot. For example, a PSSCH numbered 0 may be fed back on a PSFCH resource also numbered 0, and a PSSCH numbered 6 may be fed back on a PSFCH resource also numbered 6. The PSFCH resource of the PSSCH is started with a sub-channel number 0 and an SL transmission slot number 0, and is indicated by a bitmap. It is expressed by using a formula. For an i^{th} SL transmission slot in the bound PSSCH slots, if a number of a sub-channel in the V2X communication resource pool in the SL transmission slot is j, a PSFCH resource set corresponding to the sub-channel j in the SL transmission slot is:

[(i+j·N_{PSSCH}^{PSFCH})·M_{subch,slot}^{PSFCH},(i+1+j·N_{PSSCH}^{PSFCH})·M_{subch,slot}^{PSFCH}−1], where 0≤i≤N_{PSSCH}^{PSFCH} and 0≤i<N_{subch}. It can be learned from FIG. 9 that, if a transmit end UE-B occupies two sub-channels to send PSSCHs, for example, a PSSCH numbered 5 and a PSSCH numbered 9, PSFCH resources corresponding to the PSFCHs are also numbered 5 and 9, and the PSFCH resources are not continuous in frequency domain.

Seventh: A Service Scenario Supporting the PSFCH Feedback

In the NR system, V2X communication supports unicast, multicast, and broadcast. The multicast includes two scenarios: multicast 1 and multicast 2. Physical-layer HARQ-ACK feedback is supported in unicast and multicast scenarios.

In the unicast scenario, one transmit end UE and one receive end UE may form a unicast connection pair. When the HARQ-ACK feedback is enabled on a unicast link, in a case in which the receive end UE can correctly decode a PSCCH corresponding to a PSSCH, if the PSSCH is correctly decoded, the receive end UE feeds back, to the transmit end UE, a PSFCH sequence that carries ACK information. If the PSSCH is incorrectly decoded, the receive end UE feeds back, to the transmit end UE, the PSFCH sequence that carries the NACK information.

In a scenario of multicast 1 (NACK-only), when the HARQ-ACK feedback is enabled on a multicast link, in a case in which an intra-group receive end UE can correctly decode a PSCCH corresponding to a PSSCH, if the PSSCH is incorrectly decoded, the receive end UE feeds back, to the transmit end UE, a PSFCH sequence that carries NACK information. If the PSSCH is correctly decoded, the receive end UE does not feed back any information to the transmit end UE.

In a scenario of multicast 2 (NACK/ACK), when the HARQ-ACK feedback is enabled on a multicast link, in a case in which an intra-group receive end UE can correctly decode a PSCCH corresponding to a PSSCH, if the PSSCH is correctly decoded, the receive end UE feeds back, to the transmit end UE, a PSFCH sequence that carries ACK information. If the PSSCH is incorrectly decoded, the receive end UE feeds back, to the transmit end UE, a PSFCH sequence that carries NACK information.

Eighth: Generation of a PSFCH Sequence

The PSFCH sequence may be generated based on a ZC sequence with a low peak-to-average ratio. The PSFCH sequence occupies two continuous orthogonal OFDM symbols in time domain, and may be one PRB in frequency domain. Specifically, the PSFCH sequence is generated in the following manner.

First, a basic sequence r(n) may be generated based on a sequence length, where 0≤n≤M_{ZC}. Then, phase rotation is performed on the basic sequence r(n) to obtain a multiplexable low peak-to-average ratio sequence, where the low peak-to-average ratio sequence meets the following formula (2):

r^{α}^{ₗ}(n)=r(n)*e^{jα}^{ₗ}ⁿ,0≤n<M_{ZC}; Formula (2)

M_{ZC}=12, l represents a number of an OFDM symbol in a PSFCH transmission slot, for example, l=0 represents a first OFDM symbol in a current PSFCH transmission slot, and αₗ represents a phase rotation value. That is, a plurality of users may use different phase rotation values αₗ to generate different PSFCH sequences, and each PSFCH sequence may be code-division multiplexed on one PRB for sending. Because the receive end UE needs to feed back the ACK/NACK information, at least two sequences corresponding to different values αₗ need to be allocated to each user. The phase rotation value αₗ may meet the following formula (3):

$${α}_{l} = \frac{2 π}{{N}_{sc}^{PRB}} ( ( {m}_{0} + {m}_{cs} + {n}_{cs} ( {n}_{s , f}^{μ} , l + {l}^{′} ) ) mod {N}_{sc}^{PRB} ) 0 \leq n < {M}_{ZC} ; \qquad Formula ( 3 )$$

N_{sc}^{PRB} represents a number of sub-carriers in one PRB, and in the NR system, a value of N_{sc}^{PRB} may be 12. mod ( ) represents modulo, n_{s,f}^{μ} represents a number of an SL transmission slot corresponding to a current sub-carrier spacing μ in a radio frame, l′ represents a symbol index relative to the first OFDM symbol in the current PSFCH transmission slot, m₀ represents a phase of ACK in a PSFCH resource pair, and m_{cs} represents a phase offset of a NACK sequence relative to an ACK sequence in a PSFCH resource pair. A feedback resource pair may be available for the HARQ-ACK. One sequence may be used for ACK feedback, and the other sequence may be used for NACK feedback. As described above, in the NR system, V2X communication supports physical layer HARQ-ACK feedback in the unicast and multicast scenarios. For different service types, a value of m_{cs} may be determined based on Table 1 and Table 2. Table 1 is a phase mapping relationship of a PSFCH resource pair in the unicast scenario and the scenario of multicast 2. Table 2 is a phase mapping relationship of a PSFCH resource pair when there is a scheduling request (SR) for a format 0 (format 0) of a physical uplink control channel (PUCCH) in the scenario of multicast 1.

TABLE 1

| HARQ-ACK value | 0 | 1 |
|---|---|---|
| Sequence cyclic shift | m_{cs} = 0 | m_{cs} = 6 |

TABLE 2

| HARQ-ACK value | 0 | 1 |
|---|---|---|
| Sequence cyclic shift | m_{cs} = 0 | N/A |

A function n_{cs}(n_{s,f}^{μ},l) may satisfy the following formula (4):

$${n}_{cs} ( {n}_{s , f}^{μ} , l ) = {\sum }_{m = 0}^{7} {2}^{m} c ( 8 {N}_{symb}^{slot} {n}_{s , f}^{μ} + 8 l + m ) , \qquad Formula ( 4 )$$

N_{symb}^{slot} represents a number of continuous time domain symbols in one SL transmission slot. In the NR system, a value of N_{symb}^{slot} may be 14, m is an integer whose value ranges from 0 to 7, and c(i) represents a numerical value of a sequence number i in a pseudo-random sequence. An initial value for generating the pseudo-random sequence is cᵢₙᵢₜ=n_{ID}, and n_{ID} is configured by a higher layer. If no “ID is configured by the higher layer, n”=0

A pseudo-random sequence c(n) whose length is M_{PN} may be generated by cyclic shift of a gold sequence whose length is 31, n=0, 1, . . . , M_{PN}−1, where the gold sequence is two m sequences, namely, x₁(n) and x₂(n). A generation process of c(n) is as follows:

c(n)=(x₁(n+N)+x₂(n+N))mod2

x₁(k+31)=(x₁(k+3)+x₁(k))mod2,where

x₂(k+31)=(x₂(k+3)+x₂(k+2)+x₂(k+1)+x₂(k))mod2

N_{c}=1600, x₁(0)=1, x₁(n)=0, n=1, 2, . . . , 30, and x₂(n) may be determined by using

$${c}_{init} = {\sum }_{i = 0}^{30} {x}_{2} ( i ) \cdot {2}^{i} .$$

Ninth: A PSFCH Resource Location

If one PSSCH occupies N_{subch}^{PSSCH} sub-channels, the PSSCH corresponds to N_{subch}^{PSSCH}·M_{subch,slot}^{PSFCH}·N_{CS}^{PSFCH} PSFCH resource pairs, where N_{CS}^{PSFCH} represents a number of PSFCH sequence pairs that can be multiplexed on a PSFCH resource of one PRB configured in the V2X communication resource pool. As described above, M_{subch,slot}^{PSFCH} represents a number of PRBs of a PSFCH resource allocated to each sub-channel in the V2X communication resource pool. In addition, the V2X communication resource pool may further limit, through configuration of N_{type}^{PSFCH}, a PSFCH resource that is available by a receive end UE that receives a PSSCH. There are the following two solutions.

If N_{type}^{PSFCH}=1 is configured by the V2X communication resource pool, the receive end UE that receives the PSSCH may use only a PSFCH resource corresponding to a first sub-channel occupied by the PSSCH, and a number of PSFCH resource pairs corresponding to the PSSCH is R_{PRB,CS}^{PSFCH}=M_{subch,slot}^{PSFCH}·N_{CS}^{PSFCH}. For example, as shown in FIG. 9, when the PSSCH occupies two sub-channels numbered 5 and 9 to transmit data, the receive end UE that receives the PSSCH can only use the PSFCH resource numbered 5 to perform feedback.

If N_{type}^{PSFCH}=N_{subch}^{PSSCH} is configured by the V2X communication resource pool, the receive end UE that receives the PSSCH may use PSFCH resources corresponding to all sub-channels occupied by the PSSCH, and a number of PSFCH resource pairs corresponding to the PSSCH is R_{PRB,CS}^{PSFCH}=N_{subch}^{PSSCH}·M_{subch,slot}^{PSFCH}·N_{CS}^{PSFCH}. For example, as shown in FIG. 9, when the PSSCH occupies the two sub-channels numbered 5 and 9 to transmit data, the receive end UE that receives the PSSCH may use the PSFCH resources numbered 5 and 9 to perform feedback.

The receive end UE selects a resource corresponding to a (P_{ID}+M_{ID})mod R_{PRB,CS}^{PSFCH} th PSFCH resource pair to feed back a PSFCH, where P_{ID} represents a physical layer source address ID carried in the SCI. For multicast 2, M_{ID} represents an ID configured for current PSSCH transmission by a higher layer of each receive end UE, and for multicast 1 or unicast, M_{ID}=0 R_{PRB,CS}^{PSFCH} resource pairs may arrange all PSFCH sequences in ascending order in which a frequency domain index is followed by a code domain index. That is, a PRB index of the PSFCH resource pair is ((P_{ID}+M_{ID})mod R_{PRB,CS}^{PSFCH})mod(R_{PRB,CS}^{PSFCH}/(N_{CS}^{PSFCH}·N_{type}^{PSFCH})). In the PRB, m₀ of the PSFCH resource pair is determined by using N_{CS}^{PSFCH} and a cyclic shift index └((P_{ID}+M_{ID})mod R_{PRB,CS}^{PSFCH})/(R_{PRB,CS}^{PSFCH}/(N_{CS}^{PSFCH}·N_{type}^{PSFCH}))┘ together, indicating rounding down. A m₀ value of a PSFCH resource pair in one PRB is shown in Table 3.

TABLE 3

m₀
Cyclic shift index

| N_{CS}^{PSFCH} | 0 | 1 | 2 | 3 | 4 | 5 |
|---|---|---|---|---|---|---|
| 1 | 0 | — | — | — | — | — |
| 2 | 0 | 3 | — | — | — | — |
| 3 | 0 | 2 | 4 | — | — | — |
| 6 | 0 | 1 | 2 | 3 | 4 | 5 |

It can be learned from the foregoing analysis that, for multicast 2, each intra-group UE uses a different PSFCH resource to perform feedback due to a different M_{ID}. Correspondingly, on a premise that each intra-group UE knows M_{ID} of another intra-group UE, the transmit end UE may also separately receives each resource pair. For multicast 1, because M_{ID}=0, for PSSCHs with a same source address P_{ID}, each intra-group UE uses a same PSFCH to feed back NACK information.

Tenth: A Selection Process of an SL Transmission Resource

This part mainly describes a process in which the transmit end UE selects the SL transmission resource in the transmission mode 2 of V2X communication in the NR system.

SL transmission supports reservation of the SL transmission resource, that is, SCI sent by the transmit end UE carries SL transmission resource reservation information in a future period of time. After receiving the SL transmission resource reservation information of the SCI, another UE excludes the reserved SL transmission resource, thereby avoiding resource collision. The SCI includes the SL transmission resource reservation information, priority information of data sent by a PSSCH this time, a source address ID, a destination address ID, and the like that are sent by the PSSCH this time.

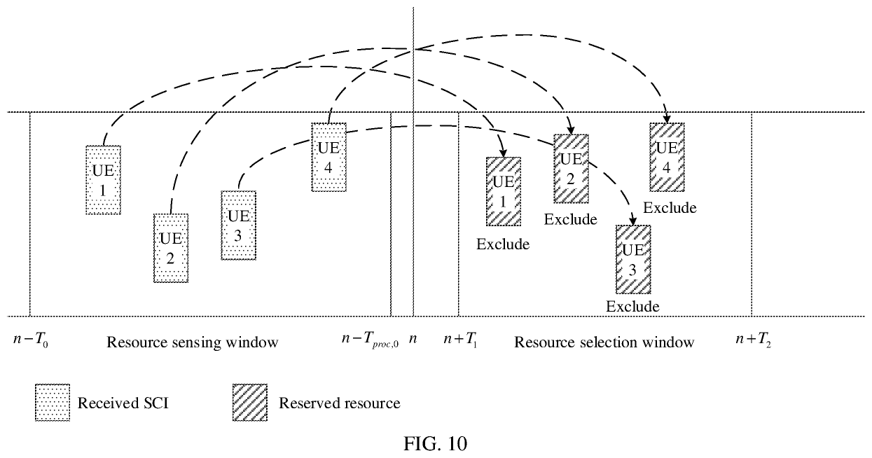

As shown in FIG. 10, the transmit end UE triggers selection of an SL transmission resource in a slot n, that is, in the slot n, the transmit end UE has data to be sent to the receive end UE. A resource sensing window may be a slot that is before the slot n and that corresponds to [n−T₀, n−T_{proc,0}], or a resource selection window may be a slot that is after the slot n and that corresponds to [n+T₁, n+T₂], where T₀, T_{proc,0}, T₁ and T₂ are all parameters configured by a higher layer. The transmit end UE senses, in the resource sensing window, SCI sent by another UE in a frequency domain resource pool, then excludes a corresponding candidate resource from the resource selection window based on a sensing result, and finally selects an SL transmission resource of the UE from remaining resources, to send to-be-sent data to the receive end UE by using the SL transmission resource. For example, if the transmit end UE obtains, in the resource sensing window, SCI sent by a UE 1, a UE 2, a UE 3, and a UE 4 through sensing, and reference signal received power (reference signal received power, RSRP) measurement results of resources that are reserved by the UE 1, the UE 2, the UE 3, and UE 4, and that are located in the resource selection window are greater than a threshold Th_{prioTX,prioRX}, the resources reserved by the UE 1, the UE 2, the UE 3, and UE 4 are excluded by the transmit end UE from the resource selection window. Specifically, a specific process in which the transmit end UE selects the SL transmission resource is as follows:

Step 1: The resource selection window may be defined as a slot that is after the trigger slot n selected by the SL transmission resource and that corresponds to [n+T₁, n+T₂].

It is assumed that a frequency resource in a V2X resource pool has a total of N_{subch} sub-channels, a corresponding sub-channel set is S={S₀, S₁, K, S_{N}_{_{subch}}₋₁}. A candidate SL transmission resource R_{x,y} may be defined as an SL transmission slot t_{y}^{SL} that is located in the resource selection window [n+T₁, n+T₂] in time domain and belongs to the V2X resource pool, and a sub-channel set that is located on a sub-channel x+j in frequency domain, where j=0, . . . , L_{subch}−1. That is, the candidate SL transmission resource R_{x,y} is represented as a set of continuous sub-channels with lengths equal to L_{subch} in frequency domain, and L_{subch} is a number of sub-channels occupied by a to-be-transmitted PSSCH/PSCCH. Therefore, a total number of candidate resources in each SL transmission slot is N_{subch}−L_{subch}+1. Any set of continuous sub-channels that meet the foregoing conditions and whose lengths are equal to L_{subch} may be considered as a candidate SL transmission resource R_{x,y}, and a number of all candidate SL transmission resources is Mₜₒₜₐₗ.

As shown in FIG. 11, if a number of sub-channels N_{subch} included in the frequency resource of the V2X resource pool is 8, a corresponding sub-channel set is S={S₀, S₁, . . . S₇}, and a number of sub-channels L_{subch} occupied by the to-be-transmitted PSSCH/PSCCH is 2. In this case, a total number of candidate SL transmission resources in each SL transmission slot is N_{subch}−L_{subch}+1=7.

Step 2: The resource sensing window may be defined as a slot that is before the trigger slot n selected by the SL transmission resource and that corresponds to [n−T₀, n−T_{proc,0}].

T₀ may be configured by a high-layer parameter to_SensingWindow, and T_{proc,0} may be determined by using Table 4. A value of μ_{SL} is related to a sub-carrier spacing (sub-carrier spacing, SCS) Δf corresponding to an SL transmission bandwidth part (bandwidth part, BWP), as shown in Table 5.

TABLE 4

| | T_{proc, 0} |
|---|---|
| μ_{SL} | (Unit: slot) |
| 0 | 1 |
| 1 | 1 |
| 2 | 2 |
| 3 | 4 |

TABLE 5

| | Δf = 2^{μSL} · 15 |
|---|---|
| μ_{SL} | (Unit: kilohertz, kHz) |
| 0 | 15 |
| 1 | 30 |
| 2 | 60 |
| 3 | 120 |
| 4 | 240 |

Step 3: The threshold Th_{prioTX,prioRX} may be defined as a function of a priority corresponding to data indicated in the SCI received by the transmit end UE and a priority corresponding to to-be-sent data of the transmit end UE.

Step 4: A set including all Mₜₒₜₐₗ candidate SL transmission resources may be defined as S_{A}.

Step 5: A candidate resource R_{x,y} may be excluded from the set S_{A} if the candidate resource R_{x,y} meets all the following conditions:

(1) The transmit end UE has no sensing slot, that is, the transmit end UE has sent a PSSCH/PSCCH in the SL transmission slot.

In the resource sensing window, the transmit end UE may also send data. Because an SL transmission system is half-duplex, that is, the UE can only be in a sending state or a receiving state, the transmit end UE cannot perform sensing by receiving a signal sent by another UE when being in the sending state. In this case, the V2X communication resource pool considers that SCI sent by the another UE in the slot includes all possible service periods, and reserves a periodic SL transmission resource. Therefore, the transmit end UE first excludes all candidate SL transmission resources R_{x,y} in a slot corresponding to a sending slot of the PSSCH/PSCCH of the transmit end UE in the SL transmission resource selection window, to exclude all SL transmission resources that may cause a collision.

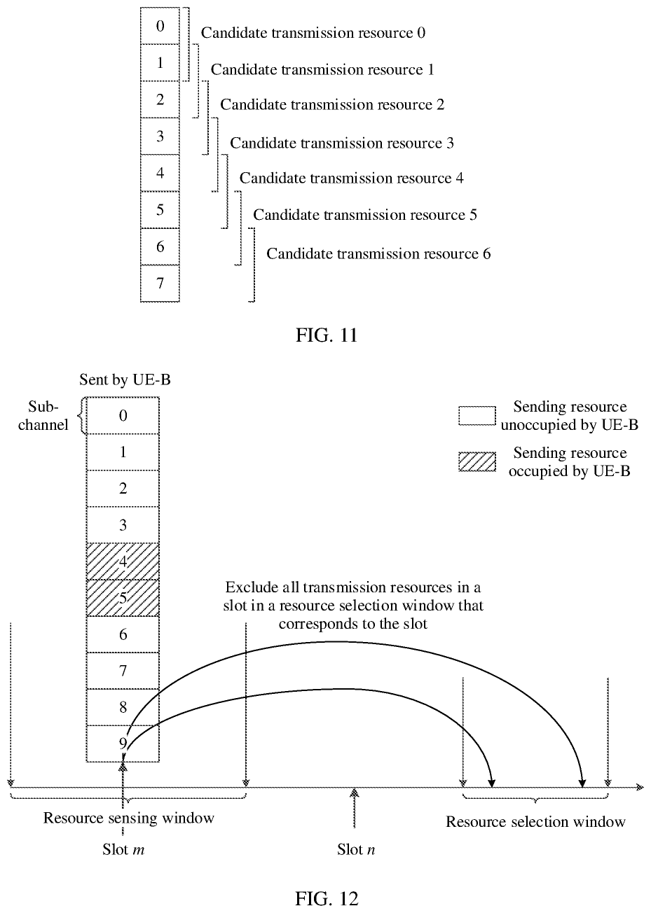

As shown in FIG. 12, UE-B sends a PSSCH/PSCCH in a slot m, that is, a sending slot of the PSSCH/PSCCH of the transmit end UE is m: The PSSCH/PSCCH occupies a sub-channel 4 and a sub-channel 5 in frequency domain. If the slot m is located in the resource sensing window, even if no UE other than the UE-B sends information in the slot m, when the UE-B subsequently selects an SL transmission resource, all SL transmission resources in a slot corresponding to the slot m in the resource selection window need to be excluded, including sub-channel 0 to sub-channel 9.

(2) An integer j meeting y+j×P_{rsvp_TX}′=m+q×P_{rsvp_RX}′ exists.

q=1, 2, . . . , Q and j=0, 1, . . . , Cᵣₑₛₑₗ−1, where Cᵣₑₛₑₗ represents a number of reservation times of the periodic SL transmission resource that is reserved by the transmit end UE and that is configured by the higher layer. P_{rsvp_TX}′ represents a logical period corresponding to a physical period P_{rsvp_TX} of the transmit end UE, and P_{rsvp_RX}′ represents a logical period corresponding to a physical period P_{rsvp_RX} indicated by the received SCI. If P_{rsvp_RX}<T_{scal}, and n′−m≤P_{rsvp_RX}′,

$$Q = ⌈ \frac{{T}_{scal}}{{P}_{rsvp \_ RX}} ⌉ ,$$

otherwise, Q=1, where T_{scal} is a gap corresponding to a parameter T₂ of the resource selection window, and T_{scal} is in a unit of ms, where n′ may be obtained in the following manner: If the slot n belongs to the V2X communication resource pool, t_{n′}^{SL}=n. If the slot n does not belong to the V2X communication resource pool, t_{n′}^{SL} is a first slot that belongs to the V2X communication resource pool and that is after the slot n, where (t₀^{SL}, t₁^{SL}, t₂^{SL}, K, t_{MAX}^{SL}) may be defined as a set of SL transmission slots belonging to the V2X communication resource pool.

In the foregoing process, P_{rsvp_TX} represents a reservation period of the transmission resource of the transmit end UE, P_{rsvp_TX} may be in a unit of millisecond ms, and a value of P_{rsvp_TX} may be provided by a higher layer parameter. In other words, P_{rsvp_TX} represents a physical period, and may include a slot in a non-V2X communication resource pool. P_{rsvp_TX}′ represents a logical period corresponding to the physical period P_{rsvp_TX}, that is, P_{rsvp_TX}′ includes only a slot that belongs to the V2X communication resource pool. Similarly, P_{rsvp_RX} represents a resource reservation period that is of another UE and that is obtained by the transmit end UE through sensing, P_{rsvp_RX} may be in a unit of ms, and a value of P_{rsvp_RX} may be provided by a resource reservation period (resource reservation period) parameter in the SCI received by the transmit end UE, that is, P_{rsvp_RX} represents a physical period, and may include a slot in a non-V2X communication resource pool. P_{rsvp_RX}′ represents a logical period corresponding to the physical period P_{rsvp_RX}, that is, P_{rsvp_RX}′ includes only a slot that belongs to the V2X communication resource pool. A conversion relationship between the physical period Pᵣₛᵥₚ and the logical period Pᵣₛᵥₚ′ is as follows:

$${P}_{rsvp}^{′} = ⌈ \frac{N}{20 ms} \times {P}_{rsvp} ⌉$$

Pᵣₛᵥₚ represents P_{rsvp_TX} or P_{rsvp_RX}, and Pᵣₛᵥₚ′ represents P_{rsvp_TX}′ or P_{rsvp_RX}. In slot configuration of the NR system, a slot configuration format is repeated in a unit of 20 ms. A period of one slot configuration is P ms, and is provided by a parameter, namely, an uplink-downlink transmission periodicity DL-UL-TransmissionPeriodicity in time division multiplexing uplink-downlink common configuration tdd-UL-DL-ConfigurationCommon higher layer signaling. N represents a number of slots that are available for SL transmission and that are included within 20 ms in a specific uplink-downlink slot configuration.

Step 6: The candidate resource R_{x,y} may be excluded from the set S_{A} if the candidate resource meets all the following conditions:

(1) The transmit end UE receives, in a sensing slot tₘ^{SL}, SCI sent by another UE, and when a resource reservation period (resource reservation period) parameter exists, if it is estimated that a time-frequency resource determined by using the SCI received by the transmit end UE in the slot t_{m+q×P}_{_{rsvp_RX}}_{′}^{SL} overlaps a candidate resource R_{x,y+j×P}_{_{rsvp_TX}}_{′}, the candidate resource R_{x,y+j×P}_{_{rsvp_TX}}_{′} may be excluded from the set S_{A}, where meanings indicated by P_{rsvp_TX}′, P_{rsvp_RX}′, q and j are the same as meanings indicated by corresponding parameters in Step 5. Details are not described herein again.

(2) The transmit end UE receives, in the sensing slot tₘ^{SL}, SCI sent by another UE, and then obtains prio_{RX} through decoding. When a resource reservation period (resource reservation period) parameter exists, P_{rsvp_RX} is decoded from the SCI, where prio_{RX} represents a priority of data indicated in the SCI. If an RSRP measurement result of the candidate resource determined by using the SCI is greater than the threshold Th_{prioTX,prioRX}, the candidate resource may be excluded from the resource selection window. The threshold Th_{prioTX,prioRX} is a function of a priority of data indicated in the SCI received by the transmit end UE and a priority of to-be-sent data of the transmit end UE.

Step 7: If a number of remaining candidate resources in the candidate resource set S_{A} is less than X % of Mₜₒₜₐₗ, a preset RSRP threshold is increased by 3 dB, and then Step 1 to Step 4 are repeated, where a value of X may be 20, 35, or 50.

Step 8: The transmit end UE reports the candidate resource set S_{A} to the higher layer, and the higher layer completes final resource selection from the set S_{A}.

The following describes the technical solutions in embodiments of this application with reference to the accompanying drawings in embodiments of this application. In descriptions of this application, “/” represents an “or” relationship between associated objects unless otherwise specified. For example, A/B may represent A or B. In this application, “and/or” describes only an association relationship for describing associated objects and represents that three relationships may exist. For example, A and/or B may represent the following three cases: Only A exists, both A and B exist, and only B exists, where A and B may be singular or plural. In addition, in descriptions of this application, unless otherwise specified, “a plurality of” means two or more than two. At least one of the following items (pieces) or a similar expression thereof refers to any combination of these items, including any combination of singular items (pieces) or plural items (pieces). For example, at least one item (piece) of a, b, or c may indicate: a, b, c, a and b, a and c, b and c, or a, b, and c, where a, b, and c may be singular or plural. In addition, to clearly describe the technical solutions in embodiments of this application, terms such as first and second are used in embodiments of this application to distinguish between same items or similar items that provide basically same functions or purposes. A person skilled in the art may understand that the terms such as “first” and “second” do not limit a quantity or an execution sequence, and the terms such as “first” and “second” do not indicate a definite difference.

Embodiments of this application are applicable to an LTE system or an NR system, or are applicable to another future-oriented new system, or the like. This is not specifically limited in embodiments of this application. In addition, the terms “system” and “network” are interchangeable.

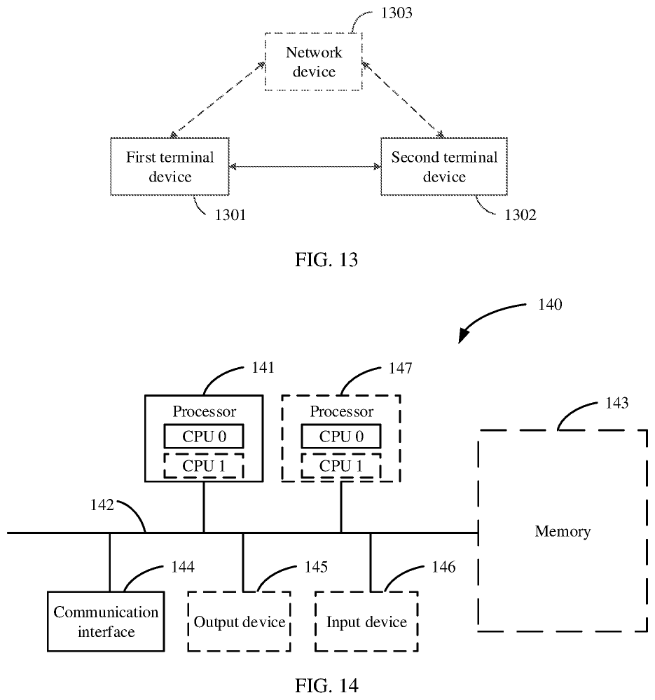

FIG. 13 is a communication system 130 according to an embodiment of this application. The communication system 130 includes a first terminal apparatus 1301 and a second terminal apparatus 1302. The first terminal apparatus 1301 is configured to determine coordination information, and send the coordination information to the second terminal apparatus 1302. The second terminal apparatus 1302 is configured to receive the coordination information from the first terminal apparatus 1301, and determine a sidelink sending resource based on the coordination information. A sequence carrying the coordination information is mapped to a first time-frequency resource, the first time-frequency resource is a subset of a second time-frequency resource, and the second time-frequency resource and a physical sidelink feedback resource overlap in time domain, and are orthogonal in frequency domain. Specific implementations and technical effect of this solution are described in detail in subsequent method embodiments. Details are not described herein again.

Optionally, as shown in FIG. 13, the communication system 130 provided in this embodiment of this application may further include a network device 1303. The network device 1303 is configured to communicate with the first terminal apparatus 1301 and/or the second terminal apparatus 1302. For example, in a broadcast scenario, the first terminal apparatus 1301 or the second terminal apparatus 1302 may send related request information to the network device 1303, to ensure that another terminal apparatus with a discontinuous reception (DRX) requirement of a service can receive a broadcast signal. This is not specifically limited in this embodiment of this application.

Optionally, the network device 1303 in this embodiment of this application is a device that accesses a terminal apparatus (including the first terminal apparatus 1301 or the second terminal apparatus 1302) to a wireless network, may be a base station, an evolved NodeB (eNodeB), a transmission reception point (TRP), a next generation NodeB (gNB) in a 5G mobile communication system, a base station in a future mobile communication system, an access node in a wireless-fidelity (Wi-Fi) system, and the like, or may be a module or unit that implements some functions of the base station, for example, may be a central unit (CU), or may be a distributed unit (DU). A specific technology and a specific device form used by the network device are not limited in this embodiment of this application. In this application, unless otherwise specified, the network device is a radio access network device.

Optionally, the terminal apparatus (including the first terminal apparatus 1301 or the second terminal apparatus 1302) in this embodiment of this application may be a vehicle, or may be an in-vehicle terminal installed on the vehicle to assist the vehicle in traveling, or a chip in the in-vehicle terminal. Alternatively, the terminal apparatus (including the first terminal apparatus 1301 or the second terminal apparatus 1302) in this embodiment of this application may be a device configured to implement a wireless communication function, for example, a terminal or a chip that can be used in a terminal. The in-vehicle terminal or terminal may be a UE, an access terminal, a terminal unit, a terminal station, a mobile station, a mobile console, a remote station, a remote terminal, a mobile device, a wireless communication device, a terminal agent, a terminal apparatus, or the like in a 5G network or a future evolved public land mobile network (PLMN). The access terminal may be a cellular phone, a cordless phone, a session initiation protocol (SIP) phone, a wireless local loop (WLL) station, a personal digital assistant (PDA), a handheld device having a wireless communication function, a computing device or another processing device connected to a wireless modem, a vehicle-mounted device or a wearable device, a virtual reality (VR) terminal apparatus, an augmented reality (AR) terminal apparatus, a wireless terminal in industrial control (industrial control) or a wireless terminal in self driving, a wireless terminal in remote medical, a wireless terminal in a smart grid, a wireless terminal in transportation safety, a wireless terminal in a smart city, a wireless terminal in a smart home, or the like. The terminal apparatus (including the first terminal apparatus 1301 or the second terminal apparatus 1302) may be located at a fixed position, or may be mobile. This is not specifically limited in this embodiment of this application.

Optionally, in this embodiment of this application, the terminal apparatus (including the first terminal apparatus 1301 or the second terminal apparatus 1302) includes a hardware layer, an operating system layer running on the hardware layer, and an application layer running on the operating system layer. The hardware layer includes hardware such as a central processing unit (CPU), a memory management unit (MMU), and a memory (also referred to as a main memory). The operating system may be any one or more types of computer operating systems that implement service processing through a process, for example, a Linux operating system, a Unix operating system, an Android operating system, an iOS operating system, or a Windows operating system. The application layer includes applications such as a browser, an address book, word processing software, and instant messaging software. In addition, a specific structure of an execution body of a method provided in embodiments of this application is not specifically limited in embodiments of this application, provided that a program that records code of the method provided in embodiments of this application can be run to perform communication according to the method provided in embodiments of this application. For example, the method provided in this embodiment of this application may be executed by the terminal apparatus (including the first terminal apparatus 1301 or the second terminal apparatus 1302), or a functional module that is in the terminal apparatus (including the first terminal apparatus 1301 or the second terminal apparatus 1302) and that can invoke and execute a program.

In other words, a related function of the terminal apparatus (including the first terminal apparatus 1301 or the second terminal apparatus 1302) in this embodiment of this application may be implemented by one device, or may be jointly implemented by a plurality of devices, or may be implemented by one or more functional modules in one device. This is not specifically limited in this embodiment of this application. It may be understood that the foregoing function may be a network element in a hardware device, may be a software function running on dedicated hardware, a combination of hardware and software, or a virtualization function instantiated on a platform (for example, a cloud platform).

For example, a related function of the terminal apparatus (including the first terminal apparatus 1301 or the second terminal apparatus 1302) in this embodiment of this application may be implemented by using a communication apparatus 140 in FIG. 14.

FIG. 14 is a schematic diagram of a structure of the communication apparatus 140 according to an embodiment of this application. The communication apparatus 140 includes one or more processors 141, a communication line 142, and at least one communication interface (in FIG. 14, only an example in which a communication interface 144 and one processor 141 are included is used for description). Optionally, the communication apparatus 140 may further include a memory 143.

The processor 141 may be a CPU, a microprocessor, an application-specific integrated circuit (ASIC), or one or more integrated circuits for controlling program execution of the solutions of this application.

The communication line 142 may include a path, configured to connect different components.

The communication interface 144 may be a transceiver module, configured to communicate with another device or a communication network, such as the Ethernet, a RAN, or a wireless local area network (WLAN). For example, the transceiver module may be an apparatus such as a transceiver or a transceiver. Optionally, the communication interface 144 may alternatively be a transceiver circuit located in the processor 141, and is configured to implement signal input and signal output of the processor.

The memory 143 may be an apparatus having a storage function. For example, the memory may be a read-only memory (ROM) or another type of static storage device capable of storing static information and instructions, may be a random access memory (RAM) or another type of dynamic storage device capable of storing information and instructions, or may be an electrically erasable programmable read-only memory (EEPROM), a compact disc read-only memory (CD-ROM) or another compact disc storage, optical disc storage (including a compressed optical disc, a laser disc, an optical disc, a digital versatile disc, a Blu-ray disc, or the like), a magnetic disk storage medium or another magnetic storage device, or any other medium capable of carrying or storing expected program code in a form of an instruction or a data structure and capable of being accessed by a computer. This is not limited thereto. The memory may exist independently, and is connected to the processor through the communication line 142. The memory may alternatively be integrated with the processor.

The memory 143 is configured to store computer-executable instructions for performing the solutions in this application, and the processor 141 controls execution of the computer-executable instructions. The processor 141 is configured to execute the computer-executable instructions stored in the memory 143, to implement a communication method provided in embodiments of this application.

Alternatively, in this embodiment of this application, the processor 141 may implement a processing-related function in a communication method provided in the following embodiment of this application, and the communication interface 144 may be responsible for communicating with another device or a communication network. This is not specifically limited in this embodiment of this application.

The computer-executable instructions in this embodiment of this application may alternatively be referred to as application code. This is not specifically limited in embodiments of this application.

In specific implementation, in an embodiment, the processor 141 may include one or more CPUs, for example, a CPU 0 and a CPU 1 in FIG. 14.

In specific implementation, in an embodiment, the communication apparatus 140 may include a plurality of processors, for example, the processor 141 and a processor 147 in FIG. 14. Each of the processors may be a single-core (single-CPU) processor, or may be a multi-core (multi-CPU) processor. The processor herein may be one or more devices, circuits, and/or processing cores configured to process data (for example, computer program instructions).

During specific implementation, in an embodiment, the communication apparatus 140 may further include an output device 145 and an input device 146. The output device 145 communicates with the processor 141, and may display information in a plurality of manners.

The communication apparatus 140 may be a general-purpose apparatus or a dedicated apparatus. For example, the communication apparatus 140 may be a desktop computer, a portable computer, a network server, a personal digital assistant (personal digital assistant, PDA), a mobile phone, a tablet computer, a wireless terminal apparatus, an in-vehicle terminal apparatus, an embedded device, or a device having a similar structure in FIG. 14. A type of the communication apparatus 140 is not limited in this embodiment of this application.

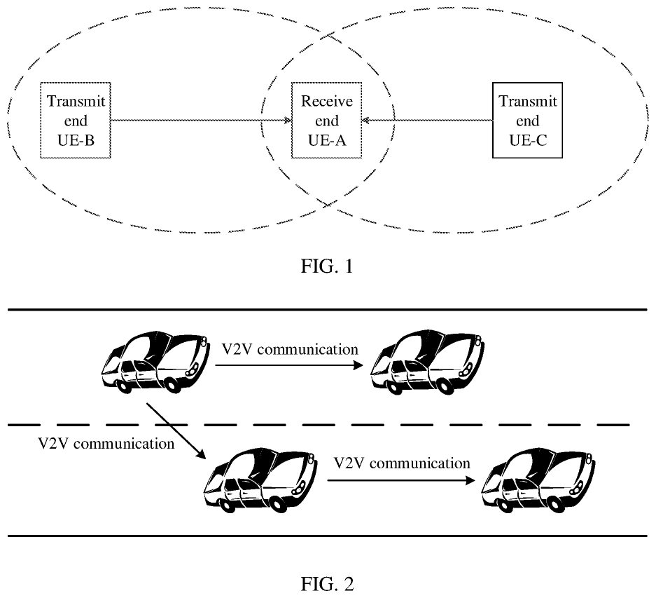

The following describes the communication method provided in embodiments of this application in detail with reference to FIG. 1 to FIG. 14.

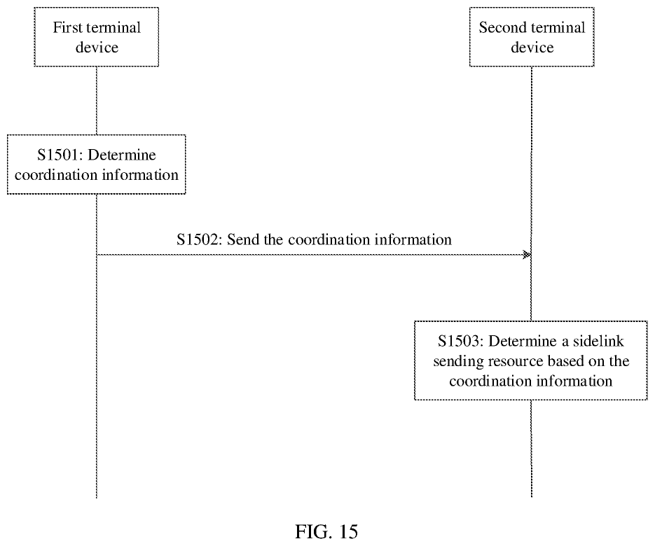

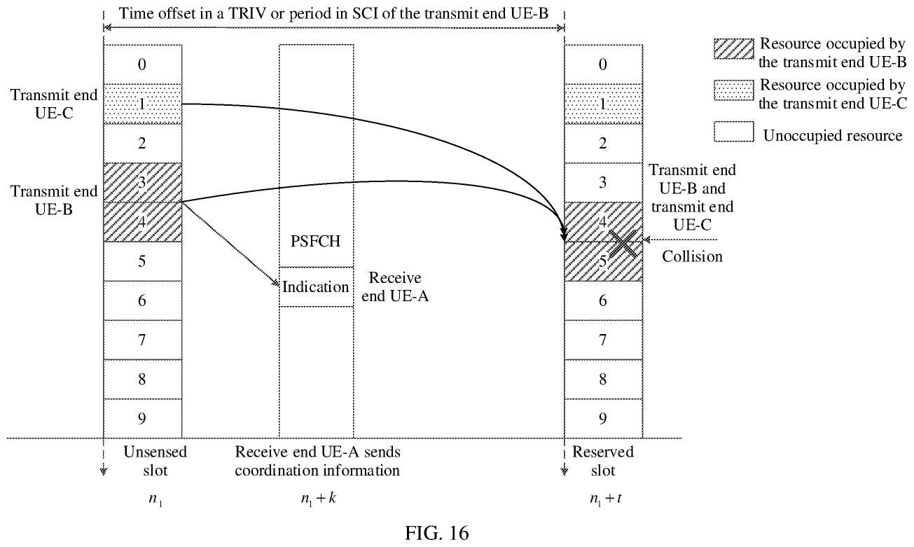

FIG. 15 shows a communication method according to an embodiment of this application. The communication method includes the following steps.

S1501: A first terminal apparatus determines coordination information. The coordination information is used to assist a second terminal apparatus in determining a sidelink sending resource.

In a possible implementation, the coordination information includes first information, the first information indicates a resource usage status in a first slot, and the second terminal apparatus sends a physical sidelink channel in the first slot. For example, in an NR system, the physical sidelink channel includes a PSSCH and/or a PSCCH.

Optionally, that the first information indicates a resource usage status in the first slot includes: The first information indicates resource usage statuses of M sub-channels in the first slot, and M is a number of sub-channels configured in a resource pool. Alternatively, the first information indicates resource usage statuses of sub-channels other than M₁ sub-channels in M sub-channels in the first slot, M is a number of sub-channels configured in the resource pool, and M₁ is a number of sub-channels occupied by the second terminal apparatus to send the physical sidelink channel in the first slot. The resource pool is a V2X communication resource pool in which the first terminal apparatus and the second terminal apparatus are located. This is uniformly described herein, and details are not described below.

Optionally, resource usage statuses of the M sub-channels may be indicated by M bits. For example, it is assumed that a value of M is 10, the first information is “101000101”, and a high bit to a low bit respectively correspond to a sub-channel 0 to a sub-channel 9. “1” indicates that the sub-channels in the first slot are unavailable, and “0” indicates that the sub-channels in the first slot are available. In this case, 101000101 may indicate that in the first slot, the sub-channels 0, 2, 6, 8, and 9 are unavailable, and the sub-channels 1, 3, 4, 5, and 7 are available. Similarly, the resource usage statuses of the sub-channels other than the M₁ sub-channels in the M sub-channels may be indicated by M-M₁ bits. A value and a meaning of each bit are described above. Details are not described herein again. In other words, it is assumed that a number of bits included in the first information is k₁, k₁=M or k₁=M−M₁.

The following describes a case in which a value of a bit in the first information is “0” or “1” with reference to several specific examples.

For example, a value of a bit in the first information indicates whether a terminal apparatus sends a PSSCH and/or a PSCCH on a sub-channel in the first slot. Specifically, when a terminal apparatus sends a PSSCH and/or a PSCCH on a sub-channel in the first slot, that is, the sub-channel is occupied and is unavailable, a value of a corresponding bit in the first information is “1”. On the contrary, when no terminal apparatus sends a PSSCH and/or a PSCCH on the sub-channel in the first slot, a value of a corresponding bit in the first information is “0”.

For example, a value of a bit in the first information indicates whether RSRP obtained through measurement on the sub-channel in the first slot exceeds a preset threshold. The preset threshold may be determined based on a priority of data in a PSSCH that is sent by the second terminal apparatus in the first slot. Alternatively, the preset threshold may be determined by using the V2X communication resource pool. For example, when the RSRP obtained through measurement on the sub-channel in the first slot exceeds the preset threshold, that is, the sub-channel is unavailable, a value of a corresponding bit in the first information is “1”. On the contrary, when the RSRP obtained through measurement on the sub-channel in the first slot does not exceed the preset threshold, a value of a corresponding bit in the first information is “0”.

For example, a value of a bit in the first information indicates whether a sub-channel in the first slot can be preempted. Specifically, when there is SCI indicating that a PSSCH is sent on a sub-channel, but PSSCH decoding fails, it is determined that the sub-channel can be preempted, or when PSSCH decoding on a sub-channel is correct, and if an RSRP obtained through measurement on the sub-channel in the first slot exceeds the preset threshold, but a priority of data on the PSSCH is lower than a priority of the data on the PSSCH sent by the second terminal apparatus in the first slot, it is determined that the sub-channel can be preempted. The preset threshold is determined based on the priority of the data on the PSSCH sent by the second terminal apparatus in the first slot. In this case, the sub-channel that is determined to be preemptable is available. Therefore, a value of a corresponding bit in the first information is “0”. In this example, in another case other than the foregoing case, a value of a corresponding bit in the first information is “1”.

Based on the foregoing solution, in the NR system, when the second terminal apparatus sends the PSSCH and/or the PSCCH in a slot in a resource sensing window, the first terminal apparatus in this embodiment of this application may determine the coordination information including the first information. The first information indicates a resource usage status in the slot for sending the PSSCH and/or PSCCH by the second terminal apparatus. In this way, when performing resource selection subsequently, the second terminal apparatus may select a transmission resource that is not occupied by another terminal apparatus, or select a transmission resource that is occupied by another apparatus but has a lower data priority, without excluding all candidate resources in a slot that corresponds to the slot for sending the PSSCH and/or PSCCH by the second terminal apparatus and that is in the resource selection window, to avoid a possible resource conflict. Therefore, resource utilization can be improved based on this solution.

In another possible implementation, the coordination information further includes second information. The second information indicates that a first reserved resource of the second terminal apparatus collides with a reserved resource of another terminal apparatus. The first reserved resource is a reserved resource closest to the first slot, and the second terminal apparatus sends the physical sidelink channel in the first slot.

Optionally, the first reserved resource includes M₃ reserved sub-channel resources.

Optionally, the first reserved resource is indicated by a time resource indicator value (TRIV) on the physical sidelink channel of the second terminal apparatus; or the first reserved resource is indicated by a resource reservation period on the physical sidelink channel of the second terminal apparatus.

Optionally, in this embodiment of this application, the first reserved resource is used for retransmission of a first transport block TB on the physical sidelink channel of the second terminal apparatus; and/or, the first reserved resource is used for new transmission of a service to which a second TB belongs on the physical sidelink channel of the second terminal apparatus in a next period.

For example, in the NR system, when a value of TRIV is not 0 and a value of the resource reservation period is 0, the first reserved resource may be a reserved resource that is closest to the first slot and that is used for retransmission of a first TB on the PSSCH and/or the PSCCH of the second terminal apparatus. Alternatively, when a value of TRIV is 0 and a value of the resource reservation period is not 0, the first reserved resource may be a reserved resource that is closest to the first slot and that is used for new transmission of a service to which a second TB on the PSSCH and/or the PSCCH of the second terminal apparatus belongs in a next period. Alternatively, when a value of TRIV is not 0 and a value of the resource reservation period is not 0, the first reserved resource may be a reserved resource that is closest to the first slot and that is used for retransmission of a first TB on the PSSCH and/or the PSCCH of the second terminal apparatus, or the first reserved resource may be a reserved resource that is closest to the first slot and that is used for new transmission of a service to which a second TB on the PSSCH and/or the PSCCH of the second terminal apparatus belongs in a next period, or the first reserved resource may be a reserved resource that is closest to the first slot and that is used for retransmission of a first TB on the PSSCH and/or the PSCCH of the second terminal apparatus, that is closest to the first slot, and that is used for new transmission of a service to which a second TB on the PSSCH and/or the PSCCH of the second terminal apparatus belongs in a next period.

For example, as shown in FIG. 16, it is assumed that a transmit end UE-B sends a PSSCH and/or PSCCH signal on a sub-channel 3 and a sub-channel 4 in a slot n₁, and reserves resources of a sub-channel 4 and a sub-channel 5 in a slot n₁+t, that is, M₃=2. Because the transmit end UE-B cannot sense in the slot n₁, the transmit end UE-B cannot obtain resource reservation information of another UE. It is assumed that a transmit end UE-C also sends a PSSCH and/or PSCCH signal on a sub-channel 1 in the slot n₁, and the transmit end UE-C also reserves resources/a resource of the sub-channel 4 and/or the sub-channel 5 in the slot n₁+t. In other words, the reserved resources of the transmit end UE-B and the transmit end UE-C in the slot n₁+t overlap in frequency domain or partially overlap in frequency domain. In this case, the transmit end UE-B or the transmit end UE-C cannot learn that a collision may occur in the future. If a receive end UE-A can detect the collision, the receive end UE-A may notify the transmit end by using the second information that the reserved resource of the UE-B collides with a reserved resource of another UE (for example, the transmit end UE-C). For example, the second information may indicate that the reserved resource of the transmit end UE-B in the slot n₁+t collides with a reserved resource of another UE (for example, the transmit end UE-C). A sending slot of the second information may be the slot shown in FIG. 16. For selection of the sending slot of the second information, refer to descriptions in S1502. Details are not described herein again.

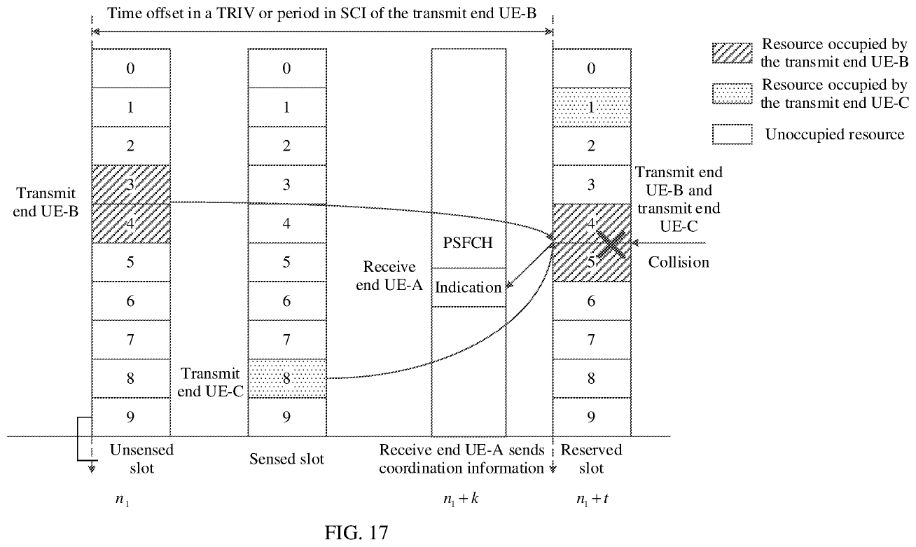

Alternatively, for example, as shown in FIG. 17, it is assumed that a transmit end UE-B sends a PSSCH and/or PSCCH signal on a sub-channel 3 and a sub-channel 4 in a slot n₁, and reserves resources of a sub-channel 4 and a sub-channel 5 in a slot n₁+t, that is, M₃=2. Because the transmit end UE-B cannot sense in the slot n₁, the transmit end UE-B cannot obtain resource reservation information of another UE. It is assumed that a transmit end UE-C also sends a PSSCH and/or PSCCH signal on a sub-channel 8 in a slot between the slot n₁ and a slot n₁+k, and the transmit end UE-C also reserves resources/a resource of the sub-channel 4 and/or the sub-channel 5 in the slot n₁+t. In other words, the reserved resources of the transmit end UE-B and the transmit end UE-C in the slot n₁+t overlap in frequency domain or partially overlap in frequency domain. In this case, the transmit end UE-B or the transmit end UE-C cannot learn that a collision may occur in the future. If a receive end UE-A can detect the collision, the receive end UE-A may notify the transmit end by using the second information that the reserved resource of the UE-B collides with a reserved resource of another UE (for example, the transmit end UE-C). For example, the second information may indicate that the reserved resource of the transmit end UE-B in the slot n₁+t collides with a reserved resource of another UE (for example, the transmit end UE-C). A sending slot of the second information may be the slot n₁+k shown in FIG. 17. For selection of the sending slot of the second information, refer to descriptions in S1502. Details are not described herein again.

Optionally, the second information may have a length of 1 bit, indicating whether the first reserved resource of the second terminal apparatus collides with a reserved resource of another terminal apparatus. For example, with reference to the example shown in FIG. 16 or FIG. 17, the second information indicates whether a reserved resource corresponding to the PSSCH and/or the PSCCH sent by the transmit end UE-B in the slot n₁ collides with a reserved resource of another UE.

Alternatively, optionally, the second information may have a length of M₃ bits, indicating whether each of M₃ sub-channel resources reserved in the first reserved resource of the second terminal apparatus collides with a reserved resource of another terminal apparatus. For example, with reference to the example shown in FIG. 16 or FIG. 17, the second information indicates whether the reserved M₃ sub-channel resources corresponding to the PSSCH and/or the PSCCH sent by the transmit end UE-B in the slot n₁ collide with a reserved resource of another UE. For example, a bit value “1” indicates that a collision occurs, and a bit value “0” indicates that a collision does not occur. In this case, second information “11” indicates that in the slot n₁+t, the sub-channel 4 and the sub-channel 5 reserved by the transmit-end UE-B collide with a sub-channel resource reserved by another UE. Alternatively, second information “10” indicates that in the slot n₁+t, the sub-channel 4 reserved by the transmit end UE-B may collide with a sub-channel resource reserved by another UE, but the sub-channel 5 reserved by the transmit end UE-B does not collide with a sub-channel resource reserved by another UE.

In a possible implementation, in the example shown in FIG. 16 or FIG. 17, the first reserved resource (namely, the sub-channel 4 and the sub-channel 5 in the slot n₁+t) of the transmit end UE-B may be used for retransmission of a same TB transmitted on the PSSCH and/or PSCCH transmitted in the slot n₁. In this case, the first reserved resource may be indicated by TRIV of first-level control information corresponding to the PSSCH and/or the PSCCH of the transmit end UE-B. In this case, it is assumed that a number of bits included in the second information is k₂, k₂=1 or k₂=M₃.

In another possible implementation, in the example shown in FIG. 16 or FIG. 17, the first reserved resource (namely, the sub-channel 4 and the sub-channel 5 in the slot n₁+t) of the transmit end UE-B may be used for new transmission of a service to which a TB transmitted on the PSSCH and/or PSCCH transmitted in the slot n₁ in a next period belongs. In this case, the first reserved resource may be indicated by a resource reservation period (resource reservation period) of first-level control information corresponding to the PSSCH and/or the PSCCH of the transmit end UE-B. In this case, it is assumed that a number of bits included in the second information is k₃, k₃=1 or k₃=M₃.

It can be learned from the foregoing that, in the hidden terminal scenario shown in FIG. 1, the first terminal in this embodiment of this application may determine the coordination information including the second information. The second information indicates that the first reserved resource of the second terminal apparatus collides with a reserved resource of another terminal apparatus. The first reserved resource is a reserved resource closest to the slot for sending the physical sidelink channel. Because the second terminal apparatus and other terminal apparatuses cannot sense the presence of each other through sensing, when the second terminal apparatus sends a signal 1 to the first terminal apparatus, and another terminal apparatus in the other terminal apparatuses sends a signal 2 to the first terminal apparatus, a transmission resource of the signal 1 and a transmission resource of the signal 2 may overlap. Consequently, the signal 1 collides with the signal 2, to affect signal reception of the first terminal apparatus. In this embodiment of this application, the first terminal apparatus may determine the coordination information including the second information, to trigger the second terminal apparatus or another terminal apparatus to perform collision confirmation or reselect a transmission resource, thereby achieving technical effect of reducing a collision probability.

The first terminal apparatus may determine the coordination information based on resource reservation information included in the physical sidelink channel sent by the second terminal apparatus. When the second terminal apparatus performs one-shot sending in the first slot, that is, the second terminal apparatus does not reserve a resource, the first terminal apparatus may determine only the first information to notify the second terminal apparatus of a resource usage status in the first slot, to assist the second terminal apparatus in selecting a subsequent transmission resource. When the second terminal apparatus reserves a transmission resource on the physical sidelink channel sent in the first slot, the first terminal apparatus may determine the second information that indicates that the first reserved resource of the second terminal apparatus collides with reserved resources of other terminal apparatuses. In this case, the foregoing two possible implementations are included. It is assumed that a length of the coordination information is S bits, S=k₁, S=k₂, or S=k₃.

Optionally, when the second terminal apparatus has a reserved resource, the first terminal apparatus may determine at least one of three types of coordination information. The three types of coordination information respectively correspond to two possible implementations of the first information and the second information. In a possible implementation, when the coordination information configured in the V2X communication resource pool includes three types of coordination information, the coordination information may further include indication information, and the indication information indicates that the coordination information includes the first information and/or the second information. That is, the indication information indicates whether the coordination information includes valid first-type coordination information, whether the coordination information includes valid second-type coordination information, and whether the coordination information includes valid third-type coordination information. It is assumed that the bit value 1 indicates that the valid first-type coordination information, second-type coordination information, or third-type coordination information is included, and bits corresponding to the first-type coordination information, the second-type coordination information, or the third-type coordination information are sorted in descending order. If a value of the indication information is “100”, it indicates that the first terminal apparatus determines only the first-type coordination information. If the indication information is “101”, it indicates that the first terminal apparatus determines the first-type coordination information and the third-type coordination information.

Optionally, the indication information may be located before the three types of coordination information, so that the second terminal apparatus can identify different types included in the received coordination information, and select a transmission resource based on the coordination information, thereby achieving technical effect of improving resource utilization and/or reducing a collision probability.

When the coordination information further includes indication information, it is assumed that a length of the coordination information is S bits, and a length of the indication information is p bits, S=p+sum(kᵢ), where sumo represents a sum, represents a type of the coordination information determined by the first terminal apparatus, and a value of i may be 1, 2, or 3.

S1502: The first terminal apparatus sends the coordination information to the second terminal apparatus. Correspondingly, the second terminal apparatus receives the coordination information from the first terminal apparatus. A sequence carrying the coordination information is mapped to a first time-frequency resource, the first time-frequency resource is a subset of a second time-frequency resource, and the second time-frequency resource and a physical sidelink feedback resource overlap in time domain, and are orthogonal in frequency domain.

In a possible implementation, a slot in which the second time-frequency resource is located is a slot that is after a first slot and in which a first physical sidelink feedback resource is located at a gap greater than K₁ slots from a last symbol in the first slot, and the second terminal apparatus sends a physical sidelink channel in the first slot.

In another possible implementation, a slot in which the second time-frequency resource is located is a slot that is before a second slot and in which a first physical sidelink feedback resource is located at a gap greater than K₂ slots from a first symbol in the second slot. The second slot is a slot in which a first reserved resource of the second terminal apparatus is located, the first reserved resource is a reserved resource closest to the first slot, and K₁ or K₂ is a minimum time gap configured by a higher layer for sending the coordination information. Alternatively, K₁ or K₂ is a minimum time gap K fed back by HARQ-ACK in the conventional technology.

Optionally, when both K₁ and K₂ are configured at the higher layer, a sending slot determined by using K₁ or a sending slot determined by using K₂ may be selected to send the coordination information. In a possible implementation, the sending slot determined by using K₁ is before the sending slot determined by using K₂. Therefore, an advantage of selecting the sending slot determined by using K₁ to send the coordination information is that the second terminal apparatus may be prompted as early as possible, to trigger the second terminal apparatus to perform SL resource selection, reselection, or collision confirmation as early as possible. An advantage of selecting the sending slot determined by using K₂ to send the coordination information is that more time may be provided to the first terminal apparatus, so that the first terminal apparatus generates more comprehensive and reliable coordination information.

It should be noted that the sending slot determined by using K₁ is more suitable for sending the coordination information including the first information, and the sending slot determined by using K₂ is more suitable for sending the coordination information including the second information. Certainly, the coordination information including the second information may alternatively be sent by using the sending slot determined by using K₁, and the coordination information including the first information may be sent by using the sending slot determined by using K₂. This is not specifically limited in this embodiment of this application.

Optionally, the second time-frequency resource includes J*M third time-frequency resources, and the J*M third time-frequency resources are sequentially allocated to M sub-channels in J slots in a manner of frequency domain first and then time domain. The J slots are slots corresponding to the second time-frequency resource determined based on K₁ or K₂, and M is a number of sub-channels configured in a resource pool. Herein, that the second time-frequency resource includes J*M third time-frequency resources may be understood as that the second time-frequency resource includes the J*M third time-frequency resources, or the second time-frequency resources are evenly divided into the J*M third time-frequency resources in bandwidth.

Optionally, the first time-frequency resource includes M₁ third time-frequency resources in the J*M third time-frequency resources. M₁ is a number of sub-channels occupied by the second terminal apparatus to transmit and send a physical sidelink channel in the first slot, and M₁ is a positive integer less than or equal to M.

For example, in the NR system, a slot in which the physical sidelink feedback resource is located may be a PSFCH slot corresponding to a PSSCH and/or a PSCCH sent by the second terminal apparatus.

Specifically, the mapping, to a first time-frequency resource, a sequence carrying the coordination information mainly includes the following steps.

First, the sequence carrying the coordination information is determined.

For example, a method similar to that in Table 1 may be used. That is, two sequences may be generated based on values of two m_{cs}, to correspond to different values of a same bit. In this case, to-be-sent coordination information whose length is S bits requires 2*S sequences in total, which may also be referred to as S sequence pairs. Each sequence pair includes two sequences whose bit values are respectively “0” and “1”. The sequence Seq(2*i) may be a sequence corresponding to the bit value “0”, and the sequence Seq(2*i+1) may be a sequence corresponding to the bit value “1”, where i represents a sequence number of a sequence pair, and i=0, 1, . . . , S−1. The first terminal apparatus may select, based on the to-be-sent coordination information, S sequences from the S sequence pairs to send.

Alternatively, for example, a carrying manner in which four sequences correspond to two bits of coordination information may be used. In this case, to-be-sent coordination information whose length is S bits requires 4*ceil (S/2) sequences in total, which may also be referred to as a set of ceil (S/2) sequences, and ceil indicates rounding up. Each sequence set includes four sequences whose bit values are respectively “00”, “01”, “11”, and “10”. The sequence Seq(4*i) may be a sequence corresponding to the bit value “00”. The sequence Seq(4*i+1) may be a sequence corresponding to the bit value “01”. The sequence Seq(4*i+2) may be a sequence corresponding to the bit value “11”. The sequence Seq(4*i+3) may be a sequence corresponding to the bit value “10”, where i represents a sequence number of an ordered set, and i=0, 1, . . . , and ceil(S/2)−1. The first terminal apparatus may select, based on the to-be-sent coordination information, ceil (S/2) sequences from the ceil (S/2) sequence sets to send.

Based on comparison between the foregoing two examples, on a side of the second terminal apparatus, because each sequence needs to be detected, calculation amounts of the two implementations are basically equal. However, on the side of the second terminal apparatus, the manner of selecting ceil (S/2) sequences from ceil (S/2) sequence sets to send may reduce a number of sequences that need to be sent by half compared with the manner of selecting S sequences from S sequence pairs to send.

Then, a time domain location of the second time-frequency resource is determined.

In this embodiment of this application, because the sequence carrying the coordination information is mapped to the first time-frequency resource, the first time-frequency resource is a subset of the second time-frequency resource, the second time-frequency resource and the physical sidelink feedback resource overlap in time domain, and are orthogonal in frequency domain. Therefore, this step is equivalent to determining a sending slot of the coordination information.

In a possible implementation, the example shown in FIG. 16 is used as an example. The sending slot of the coordination information may be the slot m₁+k shown in FIG. 16. The slot n₁+k is a first PSFCH slot at a gap greater than K₁ slots from a last symbol of a slot n₁ after the slot n₁, is sent on the PSSCH and/or PSCCH of the transmit end UE-B. K₁ is a minimum time gap for sending the coordination information. That is, k≥K₁, and n₁+k is a PSFCH slot closest to n₁ after the slot n₁ is sent on the PSSCH and/or PSCCH of the transmit end UE-B.

In another possible implementation, the example shown in FIG. 16 is used as an example. The sending slot of the coordination information may alternatively be the slot n₁+k shown in FIG. 17. The slot n₁+k is a first PSFCH slot that is before a slot n₁+t in which a first reserved resource of the transmit end UE-B is located and that is at a gap greater than K₂ slots from a first symbol of the slot n₁+t. K₂ is a minimum time gap for sending the coordination information. The first reserved resource may be indicated by a TRIV or a resource reservation period of the first-level control information corresponding to the PSSCH and/or the PSCCH of the transmit end UE-B. That is, k≤t−K₂, and n₁+k is a PSFCH slot that is before the slot n₁+t in which the first reserved resource of the transmit end UE-B is located, and that is closet to n₁+t.

Then, the frequency domain location of the second time-frequency resource is determined.

In this embodiment of this application, the second time-frequency resource is orthogonal to the PSFCH resource for sending HARQ-ACK information in the conventional technology in frequency domain. Specifically, in the conventional technology, as described above, the V2X communication resource pool configures a bit map for HARQ-ACK feedback, and the bit map indicates whether each PRB is a PSFCH resource available for HARQ-ACK feedback. If “1” in the bit map indicates that a corresponding PRB is a PSFCH resource available for HARQ-ACK feedback, in this embodiment of this application, a bit “0” indicates that the corresponding PRB is available for sending coordination information.

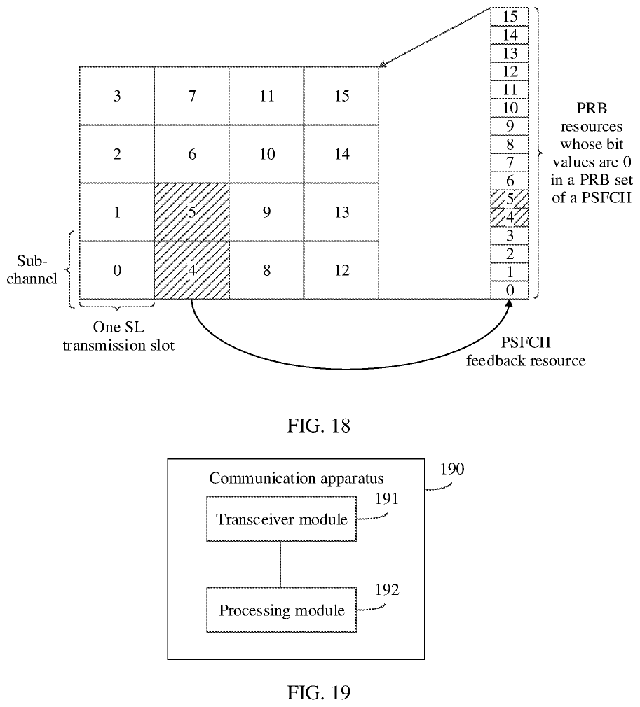

For example, as shown in FIG. 18, the first time-frequency resource may be understood as a set of PRBs numbered 4 and 5 in a PSFCH slot, and the second time-frequency resource may be understood as a set of PRBs numbered 0 to 15 in a PSFCH slot. The second time-frequency resource includes 15 third time-frequency resources, and each third time-frequency resource includes one PRB.

In this embodiment of this application, the J*M third time-frequency resources are sequentially allocated to the M sub-channels in the J slots in a manner of frequency domain first and then time domain. M is a number of sub-channels configured in a resource pool. The J slots are slots corresponding to the second time-frequency resource determined based on K₁ or K₂. Optionally, K₁ or K₂ may be a minimum time gap K for HARQ-ACK feedback in the conventional technology. The second time-frequency resource is related to a period configuration parameter N_{PSSCH}^{PSFCH}. Therefore, J is related to the period configuration parameter N_{PSSCH}^{PSFCH} of the PSFCH resource, and J≤N_{PSSCH}^{PSFCH}. In a possible implementation, J=N_{PSSCH}^{PSFCH}, and in a possible implementation, J<N_{PSSCH}^{PSFCH}. In other words, the J slots are all or part of slots in a binding window indicated by the bitmap configured for the V2X communication resource pool. It is expressed by using a formula. It is assumed that the second time-frequency resource includes P PRBs in total. In this case, each third time-frequency resource includes Q=floor(P/(J*N_{subch})) PRB resources, where N_{subch} is a number of sub-channels configured in the V2X communication resource pool, and P≥J*N_{subch}, and floor ( ) indicates rounding down. For an i^{th} SL transmission slot in the bound PSSCH slots, if a number of a sub-channel in the V2X communication resource pool in the SL transmission slot is j, a third time-frequency resource corresponding to a sub-channel j in the SL transmission slot is:

[j+i·N_{PSSCH}^{PSFCH})·Q,(j+1+i·N_{PSSCH}^{PSFCH})·Q−1], where

0≤i≤J and 0≤J<N_{subch}.

In this embodiment of this application, it can be learned from FIG. 18 that if the transmit end UE-B occupies two sub-channels, in a second SL transmission slot to send a PSSCH, for example, PSSCHs numbered 4 and 5, the first time-frequency resource of the sequence carrying the coordination information corresponding to the PSSCH is a set of a fourth third time-frequency resource and a fifth third time-frequency resource. The fourth third time-frequency resource is a fourth third time-frequency resource with Q PRB resources numbered 4, the fifth third time-frequency resource is a fifth third time-frequency resource with Q PRB resources numbered 5, and Q=1. It can be learned from FIG. 18 that the third time-frequency resource numbered 4 and the third time-frequency resource numbered 5 are continuous in frequency domain of the second time-frequency resource. However, in the conventional technology shown in FIG. 9, PSFCH resources corresponding to PSSCHs numbered 5 and 9 are not continuous in frequency domain.

In this embodiment of this application, when bits “0s” indicated in the bit map are continuous, third time-frequency resources that are of sequences carrying the coordination information and that correspond to PSSCHs are continuous in frequency domain in a manner of frequency domain first and then time domain. Therefore, a time domain peak-to-average ratio of a to-be-sent signal can be reduced, so that when the coordination information is sent, an average power of the signal is increased, and an actual power of each sending sequence is increased, to finally implement technical effect of expanding a signal coverage area.

Finally, a specific mapping location (namely, the first time-frequency resource) of the sequence carrying the coordination information is determined.

It can be learned from the analysis of the foregoing embodiment that, in this embodiment of this application, determining the first time-frequency resource is essentially determining a PRB of a sequence that is in the second time domain frequency and that may be used for carrying the coordination information.

As described above, if the PSSCH and/or the PSCCH sent by the transmit end UE-B occupy one sub-channel, the receive end UE-A may send the coordination information by using Q PRBs. Correspondingly, if the PSSCH and/or the PSCCH sent by the transmit end UE-B occupy Z sub-channels, the receive end UE-A may send the coordination information by using Q*Z PRBs. In addition, the Q*Z PRBs are continuous in frequency domain of the second time-frequency resource. A number of sequence resource sets carrying the coordination information is R=Q*Z*N_{CS}^{PSFCH}. N_{CS}^{PSFCH} is a number of cyclic shift sequence pairs that can be multiplexed in one PRB configured in the V2X communication resource pool.

In a unicast scenario, only the receive end UE-A sends the coordination information to the transmit end UE-B. With reference to the foregoing example of the manner of selecting S sequences from S sequence pairs to send, in a possible implementation, PRB resources corresponding to sequences Seq (2*i) and Seq (2*i+1) carrying the coordination information are └i/N_{CS}^{PSFCH}┘, and a cyclic shift index value is i mod N_{CS}^{PSFCH}. In addition, the value m₀ of the sequence is determined based on Table 3, and then a m_{CS} value of the sequence is determined based on the following Table 6. In another possible implementation, a PRB resource corresponding to the sequences Seq (2*i) and Seq (2*i+1) carrying the coordination information is (i)mod(Q*Z), and a cyclic shift index value is └i/(Q*Z)┘. In addition, a m₀ value of the sequence is determined based on Table 3, and a m_{CS} value of the sequence is determined based on the following Table 6.

TABLE 6

| Bit value in a sequence pair | 0 | 1 |
|---|---|---|
| Sequence cyclic shift | m_{cs} = 0 | m_{cs} = 6 |

A difference between the foregoing two implementations is that, in one implementation, the transmit end UE-A sequentially maps a to-be-sent sequence carrying the coordination information to a physical resource set of a PSFCH slot in a manner of code domain first and then frequency domain, and in another implementation, a mapping manner is a manner of frequency domain first and then code domain.

With reference to an example of a manner of selecting ceil (S/2) sequences from the ceil (S/2) sequence sets to send, for sequences Seq(4*i), Seq(4*i+1), Seq(4*i+2), and Seq(4*i+3) carrying the coordination information, a process of determining the PRB resource and the cyclic shift index value is the same as that in the foregoing example 6, and m_{CS} and m₀ may be determined based on the following Table 7 and Table 8 respectively.

TABLE 7

| Bit value in a sequence pair | 00 | 01 | 11 | 10 |
|---|---|---|---|---|
| Sequence cyclic shift | m_{cs} = 1 | m_{cs} = 4 | m_{cs} = 7 | m_{cs} = 10 |

TABLE 8

m₀
Cyclic shift index

| N_{CS}^{PSFCH} | 0 | 1 | 2 | 3 | 4 | 5 |
|---|---|---|---|---|---|---|
| 1 | 0 | — | — | — | — | — |
| 2 | 0 | 3 | — | — | — | — |
| 3 | 0 | 2 | 4 | — | — | — |

In a multicast or broadcast scenario, that is, in addition to the receive end UE-A, another receive end UE may also send coordination information to the transmit end UE-B. In this case, a number of receive end UEs for the transmit end UE-B is large. Because the second time-frequency resource is limited, there may be a case in which the first time-frequency resource cannot be allocated to each receive end UE. In this embodiment of this application, a plurality of receive end UEs may jointly send the coordination information by using a same first time-frequency resource. In addition, to avoid ambiguity on a side of the transmit end UE-B that receives the coordination information, the plurality of receive end UEs may feed back only a sequence corresponding to a bit “1”. A process of determining a specific mapping location of the sequence is same as a process of determining the specific mapping location of the sequence carrying the coordination information in the example in which ceil (S/2) sequences are selected from the ceil (S/2) sequence sets to send, and the example in which S sequences are selected from S sequence pairs to send. Details are not described herein again.

S1503: The second terminal apparatus determines a sidelink sending resource based on the coordination information.

In a possible implementation, the second terminal apparatus may select, based on the coordination information, a transmission resource that is not occupied by another UE, or select a transmission resource that is occupied by another UE but has a lower data priority.

In another possible implementation, the second terminal apparatus may trigger collision confirmation or a transmission resource reselection process based on a resource collision result indicated in the coordination information.

In this embodiment of this application, the sequence carrying the coordination information is mapped to the first time-frequency resource, the first time-frequency resource is the subset of the second time-frequency resource, and the second time-frequency resource and the physical sidelink feedback resource overlap in time domain, and are orthogonal in frequency domain. Because the physical sidelink feedback resource is less than one SL transmission slot in time domain, the coordination information is sent by using the subset of the second time-frequency resource that overlaps the PSFCH resource in time domain. Sending of the coordination information only needs to occupy some time domain resources in one SL transmission slot, without occupying at least one sub-channel in the entire slot, so that resource overheads for transmitting and sending the coordination information can be reduced. Especially when a plurality of pieces of coordination information need to be transmitted and sent, sending efficiency of other information transmission can be ensured.

It may be understood that, in the foregoing embodiments, the method and/or the step implemented by the first terminal apparatus may also be implemented by a component (for example, a chip or a circuit) that can be used in the first terminal apparatus, and the method and/or the step implemented by the second terminal apparatus may also be implemented by a component (for example, a chip or a circuit) that can be used in the second terminal apparatus.

The foregoing mainly describes the solutions provided in embodiments of this application from a perspective of interaction between network elements. Correspondingly, an embodiment of this application further provides a communication apparatus, and the communication apparatus is configured to implement the foregoing methods. The communication apparatus may be the first terminal apparatus in the foregoing method embodiment, or an apparatus including the foregoing first terminal apparatus, or a component that can be used in the first terminal apparatus. Alternatively, the communication apparatus may be the second terminal apparatus in the foregoing method embodiment, or an apparatus including the foregoing second terminal apparatus, or a component that can be used in the second terminal apparatus. It may be understood that, to implement the foregoing functions, the communication apparatus includes a hardware structure and/or a software module for performing a corresponding function. A person skilled in the art should easily be aware that, in combination with units and algorithm steps of the examples described in embodiments disclosed in this specification, this application may be implemented by hardware or a combination of hardware and computer software. Whether a function is performed by hardware or hardware driven by computer software depends on particular applications and design constraints of the technical solutions. A person skilled in the art may use different methods to implement the described functions for each particular application, but it should not be considered that the implementation goes beyond the scope of this application.

In embodiments of this application, the communication apparatus may be divided into functional modules based on the foregoing method embodiment. For example, each functional module may be obtained through division based on each corresponding function, or two or more functions may be integrated into one processing module. The integrated module may be implemented in a form of hardware, or may be implemented in a form of a software functional module. It should be noted that, in embodiments of this application, module division is an example, and is merely a logical function division. In actual implementation, another division manner may be used.

FIG. 19 is a schematic diagram of a structure of a communication apparatus 190. The communication apparatus 190 includes a transceiver module 191 and a processing module 192. The transceiver module 191 may also be referred to as a transceiver unit, and is configured to implement a transceiver function. For example, the transceiver module may be a transceiver circuit, a transceiver machine, a transceiver, or a communication interface.

That the communication apparatus 190 is the first terminal apparatus in the foregoing method embodiment is used as an example.

The processing module 192 is configured to determine coordination information, where the coordination information is used to assist the second terminal apparatus in determining a sidelink channel resource. The transceiver module 191 is configured to send the coordination information to the second terminal apparatus. A sequence carrying the coordination information is mapped to a first time-frequency resource, the first time-frequency resource is a subset of a second time-frequency resource, and the second time-frequency resource and a physical sidelink feedback resource overlap in time domain, and are orthogonal in frequency domain.

That the communication apparatus 190 is the second terminal apparatus in the foregoing method embodiment is used as an example.

The transceiver module 191 is configured to receive coordination information from a first terminal apparatus. A sequence carrying the coordination information is mapped to a first time-frequency resource, the first time-frequency resource is a subset of a second time-frequency resource, and the second time-frequency resource and a physical sidelink feedback resource overlap in time domain, and are orthogonal in frequency domain. The processing module 192 is configured to determine a sidelink transmission resource based on the coordination information.

All related content of the steps in the foregoing method embodiments may be cited in function descriptions of the corresponding functional modules. Details are not described herein again

In this embodiment, the communication apparatus 190 is presented in a form of functional modules obtained through division in an integrated manner. The “module” herein may be a specific ASIC, a circuit, a processor that executes one or more software or firmware programs, a memory, an integrated logic circuit, and/or another component capable of providing the foregoing functions.

When the communication apparatus 190 is the first terminal apparatus in the forging method embodiment. In a simple embodiment, a person skilled in the art may figure out that the communication apparatus 190 may be in a form of the communication apparatus shown in FIG. 14.

For example, the processor 141 or 147 in the first terminal apparatus shown in FIG. 14 may invoke the computer-executable instructions stored in the memory 143, to enable the first terminal apparatus to perform the communication method in the foregoing method embodiment. Specifically, a function/implementation process of the transceiver module 191 and the processing module 192 in FIG. 19 may be implemented by the processor 141 or 147 in the first terminal apparatus shown in FIG. 14 by invoking the computer-executable instructions stored in the memory. Alternatively, functions/implementation processes of the processing module 192 in FIG. 10 may be implemented by the processor 141 or 147 in the first terminal apparatus shown in FIG. 14 by invoking the computer-executable instructions stored in the memory. Functions/implementation processes of the transceiver module 191 in FIG. 19 may be implemented by using the communication interface 144 shown in FIG. 14.

Alternatively, when the communication apparatus 190 is the second terminal apparatus in the foregoing method embodiment, in a simple embodiment, a person skilled in the art may figure out that the communication apparatus 190 may also be in the form shown in FIG. 14. A specific implementation is the same as that in the case in which the communication apparatus 190 is the first terminal apparatus, and details are not described herein again.

The communication apparatus 190 provided in this embodiment can perform the foregoing communication method. Therefore, for technical effects that can be achieved by the communication apparatus 190, refer to the foregoing method embodiments. Details are not described herein again.

It should be noted that one or more of the foregoing modules or units may be implemented by software, hardware, or a combination thereof. When any one of the foregoing modules or units is implemented by software, the software exists in a form of a computer program instruction, and is stored in the memory. The processor may be configured to execute the program instruction and implement the foregoing method procedure. The processor may be built into a SoC (system-on-a-chip) or an ASIC, or may be an independent semiconductor chip. In addition to the cores used to execute the software instruction to perform operations or processing, the processor may further include a necessary hardware accelerator, such as a field programmable gate array (FPGA), a PLD (programmable logic device), or a logic circuit implementing a dedicated logical operation.

When the foregoing modules or units are implemented by using hardware, the hardware may be any one or any combination of a CPU, a microprocessor, a digital signal processor (DSP) chip, a microcontroller unit (MCU), an artificial intelligence processor, an ASIC, a SoC, an FPGA, a PLD, a dedicated digital circuit, a hardware accelerator, or a non-integrated discrete device, and the hardware may run necessary software or does not depend on software to perform the foregoing method procedures.

Optionally, an embodiment of this application further provides a chip system. The chip system includes at least one processor and an interface. The at least one processor is coupled to a memory through the interface. When the at least one processor executes a computer program or instructions in the memory, the method according to any one of the foregoing method embodiments is performed. In a possible implementation, the communication apparatus further includes a memory. Optionally, the chip system may include a chip, or may include a chip and another discrete component. This is not specifically limited in embodiments of this application.

All or some of the foregoing embodiments may be implemented by using software, hardware, firmware, or any combination thereof. When a software program is used to implement embodiments, embodiments may be implemented completely or partially in a form of a computer program product. The computer program product includes one or more computer instructions. When the computer program instructions are loaded and executed on the computer, the procedure or functions according to embodiments of this application are all or partially generated. The computer may be a general-purpose computer, a dedicated computer, a computer network, or other programmable apparatuses. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible by a computer, or a data storage device, such as a server or a data center, integrating one or more usable media. The usable medium may be a magnetic medium (for example, a floppy disk, a hard disk, or a magnetic tape), an optical medium (for example, a DVD), a semiconductor medium (for example, a solid state disk (SSD)), or the like.

Although this application is described with reference to embodiments, in a process of implementing this application that claims protection, a person skilled in the art may understand and implement another variation of the disclosed embodiments by viewing the accompanying drawings, disclosed content, and appended claims. In the claims, “comprising” does not exclude another component or another step, and “a” or “one” does not exclude a case of multiple. A single processor or another unit may implement several functions enumerated in the claims. Some measures are recorded in dependent claims that are different from each other, but this does not mean that these measures cannot be combined to produce a better effect.

Although this application is described with reference to specific features and embodiments thereof, it is clear that various modifications and combinations may be made to them without departing from the spirit and scope of this application. Correspondingly, the specification and accompanying drawings are merely example description of this application defined by the accompanying claims, and are considered as any of or all modifications, variations, combinations or equivalents that cover the scope of this application. It is clearly that a person skilled in the art can make various modifications and variations to this application without departing from the spirit and scope of this application. This application is intended to cover these modifications and variations of this application provided that they fall within the scope of protection defined by the following claims and their equivalent technologies.

What is claimed is:

1. A communication method performed by a first terminal apparatus or a component in the first terminal apparatus, wherein the method comprises:
determining coordination information, wherein the coordination information is used to assist a second terminal apparatus in determining a sidelink sending resource; and
sending the coordination information to the second terminal apparatus, wherein a sequence carrying the coordination information is mapped to a first time-frequency resource, the first time-frequency resource is a subset of a second time-frequency resource, and the second time-frequency resource and a physical sidelink feedback resource overlap in time domain, and are orthogonal in frequency domain.

2. The method according to claim 1, wherein a slot in which the second time-frequency resource is located is a slot that is after a first slot and in which a first physical sidelink feedback resource is located at a gap greater than K₁ slots from a last symbol in the first slot, and the first slot is for a physical sidelink channel of second terminal apparatus.

3. The method according to claim 1, wherein the coordination information further comprises second information, the second information indicates that the first reserved resource of the second terminal apparatus collides with a reserved resource of another terminal apparatus, the first reserved resource is a reserved resource closest to the first slot, and the first slot is for a physical sidelink channel of second terminal apparatus.

4. The method according to claim 3, wherein the first reserved resource is used for retransmission of a first transport block TB on the physical sidelink channel of the second terminal apparatus; and/or
the first reserved resource is used for new transmission of a service to which a second TB belongs on the physical sidelink channel of the second terminal apparatus in a next period.

5. The method according to claim 3, wherein the first reserved resource is indicated by a time resource indicator value TRIV on the physical sidelink channel of the second terminal apparatus; or
the first reserved resource is indicated by a resource reservation period on the physical sidelink channel of the second terminal apparatus.

6. A communication method performed by a second terminal apparatus or a component in the second terminal apparatus, wherein the method comprises:
receiving coordination information from a first terminal apparatus, wherein a sequence carrying the coordination information is mapped to a first time-frequency resource, the first time-frequency resource is a subset of a second time-frequency resource, and the second time-frequency resource and a physical sidelink feedback resource overlap in time domain, and are orthogonal in frequency domain; and
determining a sidelink sending resource based on the coordination information.

7. The method according to claim 6, wherein the method further comprises:
sends a physical sidelink channel in the first slot, wherein a slot in which the second time-frequency resource is located is a slot that is after the first slot and in which a first physical sidelink feedback resource is located at a gap greater than K₁ slots from a last symbol in the first slot; or
a slot in which the second time-frequency resource is located is a slot that is before a second slot and in which a first physical sidelink feedback resource is located at a gap greater than K₂ slots from a first symbol in the second slot, the second slot is a slot in which a first reserved resource of the second terminal apparatus is located, the first reserved resource is a reserved resource closest to the first slot, and K₁ or K₂ is a minimum time gap configured by a higher layer for sending the coordination information.

8. The method according to claim 7, wherein the coordination information further comprises second information, the second information indicates that the first reserved resource of the second terminal apparatus collides with a reserved resource of another terminal apparatus, the first reserved resource is a reserved resource closest to the first slot, and the first slot is for sending the physical sidelink channel.

9. The method according to claim 8, wherein the first reserved resource is used for retransmission of a first transport block TB on the physical sidelink channel of the second terminal apparatus; and/or
the first reserved resource is used for new transmission of a service to which a second TB belongs on the physical sidelink channel of the second terminal apparatus in a next period.

10. The method according to claim 8, wherein the first reserved resource is indicated by a time resource indicator value TRIV on the physical sidelink channel of the second terminal apparatus; or
the first reserved resource is indicated by a resource reservation period on the physical sidelink channel of the second terminal apparatus.

11. An apparatus comprising: one or more processors configured to determine coordination information, wherein the coordination information is used to assist a second terminal apparatus in determining a sidelink sending resource; and
sending the coordination information to the second terminal apparatus, wherein a sequence carrying the coordination information is mapped to a first time-frequency resource, the first time-frequency resource is a subset of a second time-frequency resource, and the second time-frequency resource and a physical sidelink feedback resource overlap in time domain, and are orthogonal in frequency domain.

12. The apparatus according to claim 11, wherein a slot in which the second time-frequency resource is located is a slot that is after a first slot and in which a first physical sidelink feedback resource is located at a gap greater than K₁ slots from a last symbol in the first slot, and the first slot is for a physical sidelink channel of second terminal apparatus; or
a slot in which the second time-frequency resource is located is a slot that is before a second slot and in which a first physical sidelink feedback resource is located at a gap greater than K₂ slots from a first symbol in the second slot, the second slot is a slot in which a first reserved resource of the second terminal apparatus is located, the first reserved resource is a reserved resource closest to the first slot, and K₁ or K₂ is a minimum time gap configured by a higher layer for sending the coordination information.

13. The apparatus according to claim 11, wherein the coordination information further comprises second information, the second information indicates that the first reserved resource of the second terminal apparatus collides with a reserved resource of another terminal apparatus, the first reserved resource is a reserved resource closest to the first slot, and the first slot is for a physical sidelink channel of second terminal apparatus.

14. The apparatus according to claim 13, wherein the first reserved resource is used for retransmission of a first transport block TB on the physical sidelink channel of the second terminal apparatus; and/or
the first reserved resource is used for new transmission of a service to which a second TB belongs on the physical sidelink channel of the second terminal apparatus in a next period.

15. The apparatus according to claim 13, wherein the first reserved resource is indicated by a time resource indicator value TRIV on the physical sidelink channel of the second terminal apparatus; or
the first reserved resource is indicated by a resource reservation period on the physical sidelink channel of the second terminal apparatus.

16. An apparatus comprising: one or more processors configured to receive coordination information from a first terminal apparatus, wherein a sequence carrying the coordination information is mapped to a first time-frequency resource, the first time-frequency resource is a subset of a second time-frequency resource, and the second time-frequency resource and a physical sidelink feedback resource overlap in time domain, and are orthogonal in frequency domain; and
determine a sidelink sending resource based on the coordination information.

17. The apparatus according to claim 16, wherein the one or more processors further configured to send a physical sidelink channel in the first slot, wherein a slot in which the second time-frequency resource is located is a slot that is after the first slot and in which a first physical sidelink feedback resource is located at a gap greater than K₁ slots from a last symbol in the first slot.

18. The apparatus according to claim 17, wherein the coordination information further comprises second information, the second information indicates that the first reserved resource of a second terminal apparatus collides with a reserved resource of another terminal apparatus, the first reserved resource is a reserved resource closest to the first slot.

19. The apparatus according to claim 18, wherein the first reserved resource is used for retransmission of a first transport block TB on the physical sidelink channel of the second terminal apparatus; and/or
the first reserved resource is used for new transmission of a service to which a second TB belongs on the physical sidelink channel of the second terminal apparatus in a next period.

20. The apparatus according to claim 18, wherein the first reserved resource is indicated by a time resource indicator value TRIV on the physical sidelink channel of the second terminal apparatus; or
the first reserved resource is indicated by a resource reservation period on the physical sidelink channel of the second terminal apparatus.
